(19) United States
(12) Patent Application Publication
(10) Pub. No.: US 2002/0002599 A1
(43) Pub. Date: Jan. 3, 2002

(54) Real-time global positioning system application in two-way mobile wireless networks

(75) Inventors: Michael D. Arner, Allston, MA (US); Christian Knapp, Stow, MA (US); David Ivan Richards III, Lowell, MA (US)

Correspondence Address: Schwegman, Lundberg, Woessner & Kluth, P.A., P.O. Box 2938, Minneapolis, MN, 55402, US

(73) Assignee: Marbles, Inc.

(21) Appl. No.: 09/801,491

(22) Filed: Mar. 8, 2001

Related U.S. Application Data
(60) Provisional application No. 60/187,712, filed on Mar. 8, 2000.
(60) Provisional application No. 60/187,736, filed on Mar. 8, 2000.
(60) Provisional application No. 60/187,711, filed on Mar. 8, 2000.

(51) Int. Cl. G06F 17/00

(52) U.S. Cl. 709/219

(57) ABSTRACT

Systems and methods are provided which includes a client receiving a global positioning system (GPS) signal, communicating the GPS signal to a universal client program, encoding the GPS signal by the universal client program, transmitting the encoded data to a server, receiving value added data an application program that has a synchronized state with the universal client program from server computer, and enabling viewing of the value added data on the client.

### RELATED APPLICATIONS

This application claims the benefit of U.S. Provisional Application Ser. No. 60/187,712 filed Mar. 8, 2000 under 35 U.S.C. 119(e).

This application claims the benefit of U.S. Provisional Application Ser. No. 60/187,736 filed Mar. 8, 2000 under 35 U.S.C. 119(e).

This application claims the benefit of U.S. Provisional Application Ser. No. 60/187,711 filed Mar. 8, 2000 under 35 U.S.C. 119(e).

This application is related to copending U.S. Application Ser. No. ______, filed Mar. 8, 2001 entitled “SYSTEM AND METHOD FOR EFFICIENT REMOTE OPERATION OF REAL-TIME GRAPHICAL APPLICATIONS.”

### FIELD OF THE INVENTION

The present invention pertains to executing graphical applications via client/server architectures, and in particular to architecture that facilitates real-time, dynamic, on-demand operation of graphical, object-oriented, server-centric applications.

### BACKGROUND OF THE INVENTION

Business and society today demand the ability to communicate, use computers, and access networked information and services at any time from any location. This demand has fueled, and has in turn been fueled by, the exploding scope of the Internet. The Internet comprises a vast, dynamic union of university and corporate intranets, local area networks (LANs), wide area networks (WANs), cellular phone networks, radio-based networks, and orbital satellite based systems providing “services.” A simultaneous explosion of Internet access devices has resulted. These Internet access devices include time-shared supercomputers, desktop workstations, laptop portables, consumer-oriented personal computers, Internet capable TV and game systems, handheld devices, cellular phones, kiosk displays, ATM machines, and embedded processors, all of varying compatibility with one another. These devices are sometimes called “client systems.” Each such device usually runs some type of operating system such as Windows® (95/98/NT/2000/CE), Linux®, Solaris®, Virtual Machine® (VM), Macintosh® OS, Palm® OS, again varying widely in compatibility with one another. The application software for these devices is written in a multitude of languages including C, C++, Visual Basic, and Java. Lastly, an enormous quantity of important information resides in legacy systems, such as databases, e-mail systems, hypertext markup language/extensible markup language (HTML/XML) pages, and other various proprietary repositories and formats.

The complex business of organizing useful systems from this myriad of networks, devices, operating systems, languages, applications, and legacy systems to create marketable products and value-added services is referred to generally known as “systems integration.” There is increasing demand for effective software tools, methods, and processes to facilitate mobile systems integration, with an emphasis on reusability, scalability, manageability, cost-effectiveness, and rapid deployment.

The complexity of mobile systems integration often leads to prohibitively high total cost of ownership. The investment required to develop, deploy and maintain effective mobile application systems increase dramatically as broader cross-platform support is demanded. There are significant financial risks associated with adopting any integration strategy that is fundamentally inadequate in some way. Of fundamental importance are effective cross-platform support, optimized performance, information security, normalized end-user experience, rapid time-to-market development/deployment, effective system administration (including upgrading), and seamless integration with legacy data and processes.

Efforts to address these issues with what were to be device-independent languages such as Java have not been successful. Efforts to standardize a Web browser interface have met with limited success on corporate Intranets, but have failed when encountering the bandwidth restrictions of mobile computing. Even attempts to standardize a completely Microsoft®-based solution using NT®, Windows® and Windows CE® have been thwarted by the bandwidth issue, particularly in the wireless mobile computing environment. The end result is that end users are forced to learn and use a multitude of graphical and non-graphical environments to access their information from different devices. This is inefficient at best, and immensely frustrating and costly at worst.

Others have tried to address the above issues by creating the concept of a client system as a Net-computer or Net-device. Envisioned as an extremely “thin” device, with a server-centric architecture, the Net-devices were supposed to be able to access remote services from anywhere at any time. Unfortunately, to give a uniform graphical experience for the end user, even the thinnest of devices ends up having to be quite robust and faces the same bandwidth limitations as the above-mentioned approaches.

From the end-user's perspective, the underlying operating systems and languages in a computer system or network are not important and should remain invisible. In addition, the end-user does not want to be concerned with bandwidth issues, but simply wants a consistent graphical experience. A single paradigm that reduces the learning curve, and is familiar whether presented on a seventeen-inch desktop monitor or a two-inch by two-inch hand held display, is what would be preferred by the end-user.

The mobile end-user also cannot accept being “data locked.” Data locking occurs when an end user has data stored in some location but is unable to access it. This problem is particularly severe in the world of mobile wireless computing. Mobile wireless users in the field often have a need to access the information stored in large corporate databases on the network. They find that, due to device and/or bandwidth limitations, they cannot effectively access or drill down into the corporate databases, and this limits their effectiveness in the field.

From the perspective of the corporate information technology group, there is a plethora of problems associated with mobile computing that must be addressed. First, the group requires an environment that simplifies development, deployment and maintenance of applications at all levels of the network. Second, they need to be able to reduce the total cost of ownership and increase their ability to rapidly respond to the rate of change in today's business world. Third, the corporate information technology group must have a solution to the security issues inherent in mobile computing. It is unacceptable to have copies of sensitive corporate information stored on small mobile devices that are easily lost and/or stolen. Fourth, mobile computing needs to be able to protect against viruses and hostile code. Mobile computers with their own storage devices dramatically increase the problems of viruses and hostile code. Fifth, corporate information technology groups need the ability to allow any end user, employee, customer or supplier, to access appropriate applications and data independently of the type of device the end user is familiar with, (e.g. whether a Windows®-based personal computer or a Macintosh). Sixth, end users do not want to be involved in installing and configuring patches, upgrades or new applications. End user installed patches and upgrades lead to large support issues.

Finally, for many years to come, there will not be enough bandwidth at all levels of the network to satisfy all application and data requirements. As infrastructure providers find ways to provide more and more bandwidth, application developers and end users quickly invent new uses for the bandwidth, perpetually taking bandwidth to its limits. This produces a stratification of applications that can be run at different levels in the network, which is unacceptable for the mobile user who must be able to access and use the power of applications at all levels of the network.

Today, it is increasingly common for client system users to access a service on a server system through a network. An example of a client/server system might be a wireless handheld computer accessing an e-mail program on a server via the Internet. Many approaches exist for enabling a user to execute and interact with a program (or “application”) stored on or otherwise accessible to a server system using a client system. One approach of a client system user to remotely run an application is to download an entire application/program from the server system and then execute the program directly on the client system. Unfortunately, there are several shortcomings to this approach, namely: (1) the client system may not be capable of running the program; (2) the program may be too burdensome to download to the client system; (3) server-side data required by the program may not be locally accessible to the client-side program; (4) the server-side data may be significantly more than can be stored on the client system; (5) there may be security concerns about program or data being transferred to client system; and (6) any changes to data shared by multiple client systems requires synchronization.

A variation on the download approach to running a program or application that solves some of the above-mentioned issues is to provide virtual machine software on the client system. This helps assure that the client system will actually be able to execute the downloaded application, substantially addressing shortcoming (1) mentioned above, and partially addressing shortcomings (2), (3) and possibly (5). A well-known example of virtual machine architecture is Java. However, there are shortcomings with this virtual machine approach, namely: (A) the client system may not be capable of running the virtual machine itself; (B) the performance of software running on a virtual machine is typically much poorer than when executing via native code; (C) it may be difficult to adapt the virtual machine software to particular client systems because of its inherent complexity; (D) the client system may have insufficient resources to run both the virtual machine software and the virtual application efficiently; (E) because of the inherent complexity of virtual machine software, it is costly to adapt the software to a large number of client platforms; and; (F) with respect to their operation, it is also difficult to assure that virtual machine software adaptations are mutually consistent across a large number of client platforms.

Another approach to running applications on a client system allows programs and data to remain on the server system and for programs to execute on the server with control of these programs offered as service to a client system. This approach addresses most the shortcomings of the virtual machine software approach discussed above, but introduces some alternative problems, namely: (a) timing aspects of the user interface may be affected by the inherent latency and limited bandwidth of the network connection; (b) there may be security concerns about the transmission of output to the client system; (c) the software necessary to access a service may not be available on the client system; and (d) different client systems may have substantially different input/output presentation requirements based on their design and method of operation.

In the server-side execution approach, it is common for a client system to connect to a server program, make a request to launch a server application and then be connected to that application. This is accomplished by well-understood methods. Another nominal aspect of this approach is that local input events are typically sent to the server by well-understood methods. For example, a simple way of informing a server application of the location of a tap upon a tap-sensitive screen would be to send two binary integer values representing the X and Y coordinate values of the click with respect to some mutually specified origin point. Such methods are presently available for use in client/server systems.

However with respect to program output sent to the client program residing on the client system from the server application, there are several possible schemes. In a very primitive scheme, the server application would send to the client program an entire graphical image of the information rendered by the program. With every change to the display made by the server application, the entire image would be sent to the client system. For example, suppose the server application maintains a graphical image consisting of 640×480 pixels at a color depth of 8 bits. If the 8-bit color value of one pixel changes, the entire graphical image, comprising 2,457,600 bits, would be sent to the client program. This scheme is obviously inefficient and is unsuited for low-bandwidth network connections.

This primitive scheme of sending the entire graphical image is dramatically improved by the modification of having the server communicate only knowledge pertaining to those pixels of the graphical image that have been changed. This optimization is well understood. However, this modified approach has significant shortcomings as well. For example, suppose the pixel colors in a large rectangular region of the graphical display on the client system are to change from red to blue. Here, the color value and location of each pixel in the region must be communicated from the server application to the client program. A further improvement would be to communicate knowledge of the rectangular region as a whole rather than knowledge of each component pixel. Such improved schemes are known to be useful and many various optimizations have been proposed to effectively communicate knowledge about graphical region updates. A significant optimization is achieved by replicating within client software the same rendering logic as is used natively in the operating system running the server application. However, there are shortcomings with this approach as well, namely: (i) the client software is completely dependent on the server application for all updates resulting in increased network usage; (ii) the perceived response time to local user events targeted to graphical objects depends on the inherent latency of the network connection; and (iii) there are typically significant resource demands on the server system required because native operating systems are not well adapted to support this approach.

However there is at least one significant shortcoming of all region-communicating schemes. Suppose a user executes a semantic action within a region of a graphical display expected by the user to produce some useful operation. For example, the user taps a stylus within the region of a tap-sensitive graphical display on the client system depicting a command button object. The location of the user tap event upon the tap-sensitive display would be communicated from the client program residing on the client system to the server application in communication with the server, as would be commonly expected in all such client/server systems. Now, the user might expect certain visual effects to occur in succession. First the user expects visual confirmation that the command button was successfully tapped. Second, the user may expect additional visual updates resulting from program operations commanded as a result of tapping the button. There is an important distinction to be made between these two different categories of visual effects. First, with regard to the first category of visual effects comprising confirmation that the button was successfully tapped, the server application might send a region update to the client program to turn the command button black, followed immediately by a region update to turn the command button white again. In the worst case, two separate update messages would be sent from the server application to the client program to accomplish this effect.

With regard now to the second category of visual effects which may result from program operations commanded by the tapping of the command button, these could be any type of visual update supported by the client program and probably do not concern themselves chiefly with the visual appearance of the command button itself. An example would be a button that caused headlines of breaking news events to display on the client system. Immediately following the tap of the command button named “GET NEWS” visual effects of the first category would occur to the region of the command button giving the user visual confirmation that the tap was successful upon the tap-sensitive display. This would then be followed by visual effects caused by operations of the server application, perhaps having retrieved current news headlines from a data source, displaying the headline text within a text field object on the client system.

It is important to note that visual effects resulting from program operations commanded by tapping the command button might not be forthcoming until some indeterminate time has elapsed from the time the button was tapped. But it is also important that the user should have immediate visual confirmation that the button was successfully tapped, independent of any subsequent visual confirmation that may or may not result from the operations commanded within the server application.

Description of Prior Art

U.S. Pat. No. 5,987,245 describes a client/server computing environment in which a user interface presenting on a client system is used to operate an application program running on a server system, and in particular describes a software system for enabling user interface presentations within such an environment. The method involves downloading an executable software component called a Presentation Engine from the server system to the client system, which is executed by virtual machine software previously installed upon the client system. Shortcomings of this approach include: 1) virtual machine software is complex and costly to implement on devices with limited resources; 2) the Presentation Engine component is downloaded as a whole, and therefore may contain a significant amount of unneeded code for aspects of user interface presentation unused during a session; and 3) the task of developing a Presentation Engine component is an additional programming burden placed on developers of client/server applications. This method does not teach how to minimize resource requirements on the client, nor does this method teach how to minimize the network bandwidth required to support a client/server session. Furthermore, this method does not teach how dynamic user interface presentations, obtaining from unanticipated user requests or unanticipated data availability, are enabled using a statically defined Presentation Engine.

U.S. Pat. No. 6,038,590 describes a client/server computing environment in which a user interface presenting on a client system is used to operate an application program running on a server system, and in particular describes a server system within such an environment. The method involves downloading an executable software component called a Presentation Engine from the server system to the client system, which is executed by virtual machine software previously installed upon the client system. Shortcomings of this approach include: 1) virtual machine software is complex and costly to implement on devices with limited resources; 2) the Presentation Engine component is downloaded as a whole, and therefore may contain a significant amount of unneeded code for aspects of user interface presentation unused during a session; and 3) the task of developing a Presentation Engine component is an additional programming burden placed on developers of client/server applications. This method does not teach how to minimize resource requirements on the client, nor does this method teach how to minimize the network bandwidth required to support a client/server session. Furthermore, this method does not teach how dynamic user interface presentations, obtaining from unanticipated user requests or unanticipated data availability, are enabled using a statically defined Presentation Engine.

U.S. Pat. No. 6,052,711 describes a client/server computing environment in which a user interface presenting on a client system is used to operate an application program running on a server system, and in particular describes a plurality of server systems and client systems within such an environment. The method involves downloading an executable software component called a Presentation Engine from the server system to the client system, which is executed by virtual machine software previously installed upon the client system. Shortcomings with this approach include: 1) virtual machine software is complex and costly to implement on devices with limited resources; 2) the Presentation Engine component is downloaded as a whole, and therefore may contain a significant amount of unneeded code for aspects of user interface presentation which are unused during a session; and 3) the task of developing a Presentation Engine component is an additional programming burden placed on developers of client/server applications. This method does not teach how to minimize resource requirements on the client, nor does this method teach how to minimize the network bandwidth required to support a client/server session. Furthermore, this method does not teach how dynamic user interface presentations, obtaining from unanticipated user requests or unanticipated data availability, are enabled using a statically defined Presentation Engine.

U.S. Pat. No. 6,005,568 describes a client/server computing environment in which a user interface presenting on a client system is used to operate an application program running on a server system. In particular is described a client software component containing a scripting language interpreter sub-component. The method involves scripts, written in a scripting language called GUIScript, which are downloaded from a server to a client and subsequently interpreted by a GUIScript interpreter component residing on the client system. The GUIScript interpreter component, which itself runs on virtual machine software already installed on the client system, may have been installed on the client system prior to a client/server session, or may have been downloaded to the client system at the beginning of the client/server session. Shortcomings of this approach include: 1) virtual machine software is complex and costly to implement on devices with limited resources; 2) there are significant performance issues resulting from a script written in GUIScript being interpreted by a GUIScript interpreter running on virtual machine software which in turn runs on native hardware; each additional interpretation/execution layer results in reduced overall performance, and increased local resource usage; 3) a GUIScript script component is downloaded as a whole, and therefore may contain a significant amount of unneeded code for aspects of user interface presentation unused during a session; 4) the task of learning a new, non-standard scripting language is an additional burden placed on developers of client/server applications; and 5) creating a GUIScript interpreter component is an additional burden placed on developers of client/server application systems. This method does not teach how to minimize resource requirements on the client, nor does method teach how to minimize the network bandwidth required to support a client/server session.

U.S. Pat. No. 6,078,321 describes a client/server computing environment in which a user interface presenting on a client system is used to operate an application program running on a server system. Further described is a client software component containing a scripting language interpreter sub-component. In particular are described methods of implementing, distributing and arranging various components within a client/server computing environment. The method involves scripts, written in a scripting language called GUIScript, which are downloaded from a server to a client and subsequently interpreted by a GUIScript interpreter component residing on the client system. The GUIScript interpreter component, which itself runs on virtual machine software already installed on the client system, may have been installed on the client system prior to a client/server session, or may have been downloaded to the client system at the beginning of the client/server session. Shortcomings of this approach include: 1) virtual machine software is complex and costly to implement on devices with limited resources; 2) there are significant performance issues resulting from a script written in GUIScript being interpreted by a GUIScript interpreter running on virtual machine software which in turn runs on native hardware; each additional interpretation/execution layer results in reduced overall performance, and increased local resource usage; 3) a GUIScript script component is downloaded as a whole, and therefore may contain a significant amount of unneeded code for aspects of user interface presentation unused during a session; 4) the task of learning non-standard scripting language is an additional burden placed on developers of client/server applications; and 5) creating a GUIScript interpreter component is an additional burden placed on developers of client/server application systems. This method does not teach how to minimize resource requirements on the client, nor does this method teach how to minimize the network bandwidth required to support a client/server session.

For the reasons stated above, and for other reasons stated below which will become apparent to those skilled in the art upon reading and understanding the present specification, there is a need for a method of and system for communicating between a client system and a server system over a network in a manner that allows for the independent execution of universal object logic on both client system and the server system, so as to minimize network bandwidth requirements. Such a method and system would be particularly useful if the method and system could minimize the amount of network bandwidth consumed during a client/server session by eliminating the need to exchange an certain categories of messages between the client and the server, while also providing an improved client user experience by producing immediate user feedback from local user events.

The introduction and applications of handheld portable electronic devices, such as the PALM PILOT™, are an area of fast growth in the consumer electronics industry. Technologies that can deliver large amounts of computing power from a server to users of such handheld portable electronic devices over low-bandwidth wireless connections provide opportunities for sophisticated, targeted delivery of information. These technologies also provide the ability to deliver graphically rich Internet-based information.

The consumer and commercial application of the global-positioning-system (GPS) to establish the geographic location of a device or client is an area of fast growth. In traditional GPS applications the “intelligence”, comprising data and programmatic logic, is resident in a portable device itself. Laptop computers with external GPS receivers can provide location information and can generate travel directions, for instance, based on map data resident on a local CD-ROM or mass storage unit. Alternatively, such data can be downloaded to the local client via a high-speed data link prior to travel.

Many databases can provide detailed information based on geographic location. The burgeoning field of Geographic Information Systems (GIS) involves mapping locations to other kinds of data such as demographic information. GIS is increasingly used in many industries, including business, travel, tourism, education, law enforcement and emergency services, such as E-911.

Current GPS applications depend upon substantially static data that accompanies the client application, typically in the form of digital maps stored on CD-ROM or other mass storage devices associated with a portable GPS unit. Also, portable GPS devices tend to be application specific, for example dedicated devices useful only for navigation. Using such devices for an entirely different function, for example guided tour information, typically requires a completely different software program and data set. Since the dedicated data set is static, and dynamic downloading of new programs and data sets is not efficient, additional data is generally inaccessible. However, with the convergence of digital networking via the Internet and the World Wide Web, and wireless communications technologies, the potential exists to unite mobile users with vast databases that can be accessed interactively using portable devices.

Raw GPS information, while useful in determining the geographic location of a client, is of limited additional value. There exists the potential for numerous applications that tie GPS information to dynamic data such as road and traffic conditions, weather, etc., all of which are useful to certain mobile users. However, the handheld devices, to which such information is preferably delivered, suffer from limitations in computing power and storage capacity relative to fixed computing resources. Present-day portable devices do not typically combine graphical interfaces with access to large databases, fast processing speeds, or information customized in response to a user's dynamic or environmental needs.

There are several U.S. patents that disclose GPS-based information systems. For example, U.S. Pat. No. 5,959,577 (the '577 patent), entitled “Method And Structure For Distribution Of Travel Information Using Network,” describes a method for processing position and travel related information through a data processing station on a data network. In one embodiment, a GPS receiver is used to obtain a measured position fix of a mobile unit. The measured position fix is reported to the data processing station, which associates the reported position to a map of the area. Typically, the measured position of the mobile unit is marked and identified by a marker on the map. The area map is then stored in the data processing station and made available for access by authorized monitor units or mobile units. An authorized monitor unit may request a specific area map by sending a request through the data network. Upon receiving a request, the data processing unit sends the area map to the monitor unit. The data processing station may also perform a database search for travel-related information, such as directions to a gasoline station. Thus, the '577 patent discloses a method for locating a GPS transmitter on a map generated at a local, fixed workstation for purposes of monitoring the position of the GPS unit. However, a shortcoming of this invention is that it does not interact with the GPS-equipped device in bi-directional fashion to send additional data to the mobile terminal.

U.S. Pat. No. 5,848,373 entitled “Computer Aided Map Location System,” describes a computer-aided map location system (CAMLS) that provides correlation and coordination of spatially related data between a computer (PDA/PC/EC) and a set of printed maps depicting surface features at desired levels of detail. A first set of constant scale printed maps substantially coincides with or is overprinted with equal area grid quadrangles of a first scale grid. The first scale grid quadrangles are identified by a first set of unique names. The PDA/PC/EC has a computer display or other computer output, a first database, and display subsystem. The first database includes the first set of unique names of the grid quadrangles of the first scale grid. The boundary lines of the respective first scale grid quadrangles are identified in the first database by latitude and longitude location. The display subsystem causes the display of a selected grid quadrangle or gridname on the PDA/PC/EC display in response to a user query. The displayed grid quadrangle or gridname is correlated with a grid quadrangle of a printed map from the first set of printed maps. The PDA/PC/EC may have access to a second database or multiple databases of latitude and longitude locatable objects (loc/objects) for display on selected grid quadrangles. Alternatively or in addition the PDA/PC/EC may incorporate a user location system such as a GPS location system for displaying the location and route of the CAMLS user on the display. Multiple level scales of grids and corresponding multiple sets of maps at the different scales are available. Communications links are provided between CAMLS computers and CAMLS users in various combinations. However, a shortcoming of this invention is that the data is not transmitted in a packetized form that allows for rapid communication and that accounts for the limited computing resources of a hand-held computer.

U.S. Pat. No. 5,946,687 (the '687 patent), entitled “Geo-Enabled Personal Information Manager,” describes a personal information manager computer program for storing names, addresses, telephone numbers and the like for personal and business contacts includes a capability for delivering geographic information in response to user requests. The personal information manager provides a display having one or more fields for entering or selecting contact information. The display also includes a number of buttons for requesting different types of geographic information, such as maps, directions, weather and yellow pages information. When the user clicks on one of the buttons, the personal information manager utilizes an address or other location identifier associated with the contact name to format a request to a geographic information server. The server uses the location identifier to retrieve the appropriate geographic information for that location, and sends the information to the personal information manager for display.

Thus, while the '687 patent discloses a software application wherein a program queries a geographic database for fixed information, the query is in the form of an address “or other location identifier” entered by the user, and does not involve real-time GPS information in the formation of database queries.

U.S. Pat. No. 5,938,721 (the '721 patent), entitled “Position Based Personal Digital Assistant,” describes a task description stored in a database accessible by a mobile computer system. The mobile computer system receives positioning information corresponding to its geographic location and indexes the database based on the positioning information when the information indicates that the mobile computer system is in a geographic location that facilitates completion of a task associated with the task description. The database may be resident in the mobile computer system or accessible in other ways, for example, via the Internet. The task description preferably includes a geocode, which corresponds to the geographic location at which completion of the task may be facilitated. The task description may also include textual, voice, or other message that can be displayed and/or played back to a user. The positioning information may be obtained from a GPS satellite, a GLONASS satellite or a pseudolite. The mobile computer system may be a portable unit, such as a PDA, or integrated within a vehicle.

Thus, the '721 patent describes the use of a database of tasks that may be performed when a mobile computer system is in the geographical vicinity that enables a task to be performed, based on GPS or other input. It also describes database access that may take place via the Internet. However, a shortcoming of the '721 patent is that it does not allow the user to query a plurality of databases and interact iteratively with a plurality of systems. Another shortcoming of the '721 patent is that the data is not transmitted in a packetized form that allows for rapid communication and that accounts for the limited computing resources of a hand-held computer.

### SUMMARY OF THE INVENTION

The above-mentioned shortcomings, disadvantages and problems are addressed by the present invention, which will be understood by reading and studying the following specification. Systems and methods are provided through which an application is executed on a server, and operated from a client operably coupled to the server. State information of the application is maintained through parallel objects on both the client and the server, thereby minimizing the communications requirements between the client and the server in the operation of the application. For example, the specific communications requirements for updating attributes of graphical objects are minimized.

In one aspect of the present invention, a method for using a universal client program to operate an application program executing on a server system includes establishing communication between the universal client program associated with a client and an application program associated with a server, and also includes operating the application program by presenting the user interface of the application program using the universal client program. In one example, operating the application program includes rendering the user interface of the application program on the client system by the universal client program, maintaining a first object-oriented hierarchy representing user interface state by the universal client program, maintaining a second object-oriented hierarchy representing user interface state by the application program, and dynamically synchronizing the first object-oriented hierarchy and the second object-oriented hierarchy by means of an event-driven synchronization protocol. The event-driven synchronization protocol contains no platform specific information, and the universal client program, as adapted to a client hardware platform, operates any application program that is adapted to execute on a server hardware platform, within the specifications of the present invention In a related aspect, the present invention includes a client system that includes a processor, a universal client program operative on the processor, software means operative on the processor for establishing communication between the universal client program and a server application program, and software means for operating the application program by presenting the user interface of the application program using the universal client program.

In another related aspect, the present invention includes a server system that includes a processor, an application program operative on the processor, software means operative on the processor for establishing communication between the a universal client program and the application program, and software means for enabling operating the application program by presenting the user interface of the application program using the universal client program.

Yet another aspect of the present invention includes a method for using a single instance of a universal client program to operate a plurality of application programs executing on a plurality of server systems, with respect to the operation of a single application, establishing communication between the universal client program and an application program, and operating the application program by presenting the user interface of the application program using the universal client program. With respect to managing a plurality of operations, sending messages to additional server programs requesting access to additional application programs, which are to be executed upon other server systems, executing the additional requested application programs on these other server systems and placing additional requested application programs in communication with the universal client program, and switching between applications such that at any given moment one particular application program is distinguished as the active application, such that during this time the active application handles all user input events.

The present invention also includes a method for using a universal client program to operate an application program executing on a server system that includes sending locally-generated protocol events to the server via protocol messages, responding to server-generated protocol events received as protocol messages, and maintaining a shared state of the application executing on the server.

In still another aspect of the present invention, a computerized apparatus includes a plurality of objects comprising an object-oriented class hierarchy, the hierarchy defining optional possible user interface elements of an application, and an application operably coupled to at least one of the plurality of objects, wherein the one or more objects defines the user interface of the application, and the application is operated by a universal client program. The one or more objects has access to the context in which the at least object is operably coupled. The one or more objects have access to information indicating when to transmit and receive an event-driven synchronization protocol message. Invocation of each method of the one or more objects is performed without regard to the details of a managing synchronization implementation, which are encapsulated within each method.

In another related aspect of the present invention, a computerized apparatus for remote client computing includes a universal client program executing on the client, and a dynamic object-oriented hierarchy representing a user interface state associated with the universal client program. The client is operably coupled through a communication network to a server executing an application program, enabling the universal client program to communicate to the application program. The communication network implements a general network protocol for communicating digital information over the communication network. The object-oriented hierarchies are synchronized dynamically using an event-driven synchronization protocol.

In still yet another aspect of the present invention a computer-readable medium includes a universal client program, and a dynamic object hierarchy representing user interface state associated with the universal client program. Another related aspect includes a computer-readable medium including a server program, an application program, and a dynamic object-oriented hierarchy representing user interface state associated with the application program.

In a further aspect, a client method for using a universal client program to operate an application program executing on a server system includes launching a universal client, managing a link request, and operating an application program on a server, through the universal client.

In another further aspect a method for enabling operation by a client of an application program executing on a server system includes launching the application program, managing link requests, and managing the application program. In another embodiment, managing the application program further comprises maintaining a first object-oriented hierarchy representing user interface state by the application program, and synchronizing dynamically the first object-oriented hierarchy and a second object-oriented hierarchy representing user interface state by a universal client program by means of an event-driven synchronization protocol.

An embodiment of present invention comprises a system that provides real-time bi-directional communication of data between a wireless client computer (e.g., a portable electronic device) in communication with a global positioning system (GPS) and with a non-local server system, via the Internet.

A further aspect of the invention is a method of performing real-time bi-directional communication of data between a wireless client system having a universal client program presenting a user interface, in communication, via the Internet, with a GPS unit and with a server system running an application program. The method comprises several actions: the first is receiving GPS signals from the GPS system on the client system. The next action is processing GPS data in the client system to yield accurate GPS location information pertaining to the geographic location of the client terminal. The next action is transmitting said GPS location information to the application program running on the server system via the Internet in packetized form, such as by TCP/IP. The next action, optionally performed in combination with the immediately previous action, is transmitting, in packetized form, user data corresponding to inputs into the user interface made by an end-user, to the application program running on a server system via the Internet. A further action, optionally performed in combination with the previous two actions, comprises time-stamping this packeted transmission to the application program running on the server system. The next action is processing GPS location information and user data in the server to access added value information useful to the end-user. The next action is transmitting, in packetized form, the added value data from the server to the client computer via the Internet. The final action is displaying the added value data on the user interface preferably using a universal client program.

In still another aspect of the present invention, a method includes receiving a GPS signal, communicating the GPS signal to a universal client program, encoding the GPS signal by the universal client program, transmitting the encoded data to a server, receiving value added data from server computer, and enabling viewing of the value added data.

In still yet another aspect of the present invention, a method includes receiving GPS data, converting the GPS data into digital representations of the latitude, longitude, and elevation, combining the digital representation with an encoded representation of user actions involving the user interface elements provided and managed by a universal client program, packetizing mobile terminal server (MTS) data and the combined data, transmitting the packetized data to a server, receiving response data from the server, including value-added information, decoding the received data, formatting the decoded data, decoding the formatted data by the universal client program, and presenting the decoded value-added information by altering an aspect of the user interface, by the universal client program.

In still a further aspect of the present invention, a method includes receiving an encoded GPS signal data from a client system, by an application program, processing the GPS data by the application program running on server system, in conjunction with another information source available to the server, and transmitting the results of the processing to the client.

In yet a further aspect of the present invention, receiving global-positioning-system-related data, decoding MTS and digital representations of the latitude, longitude, and elevation, passing the MTS and the digital representations of the latitude, longitude, and elevation an application program, preparing a database query from the MTS data and the digital representations of the latitude, longitude, and elevation, performing the database query, receiving query results by an application program, formatting the received query results into protocol messages by the application program for delivery to a universal client program, packetizing the formatted data, and transmitting the packetized data to a client.

In still yet a further aspect of the present invention, an apparatus includes a processor, a GPS receiver device, operably coupled to the processor, an operating system executing on the processor and operably coupled to the receiver device that receives, that receives output of the GPS device, and a universal client program that facilitates the operation of a plurality application programs running respectively on a plurality of operably coupled server systems, that receives the output of the GPS device from the operating system, and passes the output of the GPS device to the at least one of the application programs, and operates the functions of user interface.

The present invention involves the use of a universal client program that facilitates remote operation of an application program running on a server system via the user interface presented on the client computer. This user interface, and the proper functions thereof, are adapted to the operating system of the client system by the universal client program. The universal client program converts user input events passed by the operating system from the user interface into protocol messages for transmission.

In related embodiments, the present invention also includes means to perform the methods, computer data signals embodied in a carrier wave and representing a sequence of instructions which, when executed by a processor, cause the processor to perform the methods, and computer-readable mediums having computer-executable instructions to cause a client computer to perform the methods.

### BRIEF DESCRIPTION OF THE DRAWINGS

FIG. 1 is a block diagram of the hardware and operating environment in which different embodiments of the invention can be practiced.

FIG. 2 is a block diagram of an embodiment the system in FIG. 1 comprising a remote device that is a handheld computer connected via network interfaces through the Internet to a server system.

FIG. 3 is a block diagram of the client system of the present invention, comprising a remote device running a universal client program and communicating with server software through a network interface.

FIG. 4A is a block diagram of the universal client program referenced in FIG. 3.

FIG. 4B is a block diagram of a simplified universal client program.

FIG. 5 is a block diagram showing two mutually logically consistent object hierarchies such as would exist in embodiments of the present invention.

FIG. 6 is a block diagram of the application object referenced in FIG. 5 further detailing connectivity with universal object logic.

FIG. 7 is a block diagram of a server group and connectivity to a single client system. The internal blocks of a primary server machine are detailed.

FIG. 8 is a block diagram of the application executive referenced in FIG. 7 showing logical object groupings as depicted in FIG. 5.

FIG. 9A-9F are a sequence of diagrams showing the actions of using a user interface presented by a universal client program to perform a simple operation in a remote application program.

FIG. 9G is a block diagram of apparatus related to managing global-positioning-system information, according to an embodiment of the invention.

FIG. 9H is a block diagram of apparatus related to managing global-positioning-system information, according to an embodiment of the invention.

FIG. 9I is a diagram of a protocol message data structure for use in creating a visual object, according to an embodiment of the invention.

FIG. 9J is a diagram of a protocol message data structure for use in changing an attribute of a visual object, according to an embodiment of the invention.

FIG. 9K is a diagram of a protocol message data structure for use in destroying a visual object, according to an embodiment of the invention.

FIG. 10 is a flowchart of a client method performed according to an embodiment of the invention.

FIG. 11 is a flowchart of a client method of one embodiment of the action of launching a universal client in FIG. 10, performed according to an embodiment of the invention.

FIG. 12 is a flowchart of a method of one embodiment of the action of managing link requests in FIG. 10, performed by a client according to an embodiment of the invention.

FIG. 13 is a flowchart of a method performed in conjunction with the method in FIG. 12, by a universal client program according to an embodiment of the invention.

FIG. 14 is a flowchart of a method of one embodiment of the action of operating an application program via the universal client in FIG. 10, performed by a client according to an embodiment of the invention.

FIG. 15 is a flowchart of a method of one embodiment of the action of creating graphical user interface objects in FIG. 14, performed by a client according to an embodiment of the invention.

FIG. 16 is a flowchart of a method of one embodiment of the action of modifying attributes of graphical user interface objects in FIG. 14, performed by a client according to an embodiment of the invention.

FIG. 17 is a flowchart of a method of one embodiment of the action of managing click events of graphical user interface objects in FIG. 14, performed according to an embodiment of the invention.

FIG. 18 is a flowchart of a method performed in response to the completion of method in FIG. 16, according to an embodiment of the invention.

FIG. 19 is a flowchart of a method of one embodiment of the action of managing a local click protocol event in FIG. 17, performed by the universal object logic of the universal client program according to an embodiment of the invention.

FIG. 20 is a flowchart of a method performed by a server according to an embodiment of the invention in conjunction with client methods in FIGS. 10-19.

FIG. 21 is a flowchart of a method of one embodiment of the action of launching the application program in FIG. 20, performed by a server according to an embodiment of the invention.

FIG. 22 is a flowchart of a method of one embodiment of the action of managing link requests in FIG. 20, performed by a server according to an embodiment of the invention.

FIG. 23 is a flowchart of a method of one embodiment of the action of affirming the communication path in FIG. 22, performed according to an embodiment of the invention.

FIG. 24 is a flowchart of a method of one embodiment of the action of determining the availability of the application program on the server in FIG. 22, performed by the load balancer according to an embodiment of the invention.

FIG. 25 is a flowchart of a method of one embodiment of the action of informing the load balancer of the request in FIG. 22, performed according to an embodiment of the invention.

FIG. 27 is a flowchart of a method of one embodiment of managing the application program in FIG. 20, performed by a server according to an embodiment of the invention.

FIG. 28 is a flowchart of a method of one embodiment of the action of creating graphical user interface objects in FIG. 27, performed according to an embodiment of the invention.

FIG. 29 is a flowchart of a method of one embodiment of the action of managing click events of graphical user interface objects in FIG. 27, performed by a server according to an embodiment of the invention.

FIG. 30 is a flowchart of a method of one embodiment of the action of managing GPS information, performed by a client according to an embodiment of the invention.

FIG. 31 is a flowchart of a method of one embodiment of the action of managing GPS information, performed by a server according to an embodiment of the invention.

FIG. 32 is a flowchart of a method of one embodiment of the action of managing GPS information, performed by a client according to an embodiment of the invention.

FIG. 33 is a flowchart of a method of one embodiment of managing GPS information, performed by a server according to an embodiment of the invention.

### DETAILED DESCRIPTION OF THE INVENTION

In the following detailed description of embodiments of the invention, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical and other changes may be made without departing from the scope of the present invention. The following detailed description is, therefore, not to be taken in a limiting sense, and the scope of the present invention is defined only by the appended claims.

The detailed description is divided into four sections. In the first section, the hardware and the operating environment in conjunction with which embodiments of the invention may be practiced are described. In the second section, a particular object-oriented Internet-based implementation of the invention is described. In the third section, methods for an embodiment of the invention are provided. Finally, in the fourth section, a conclusion of the detailed description is provided.

### Hardware and Operating Environment

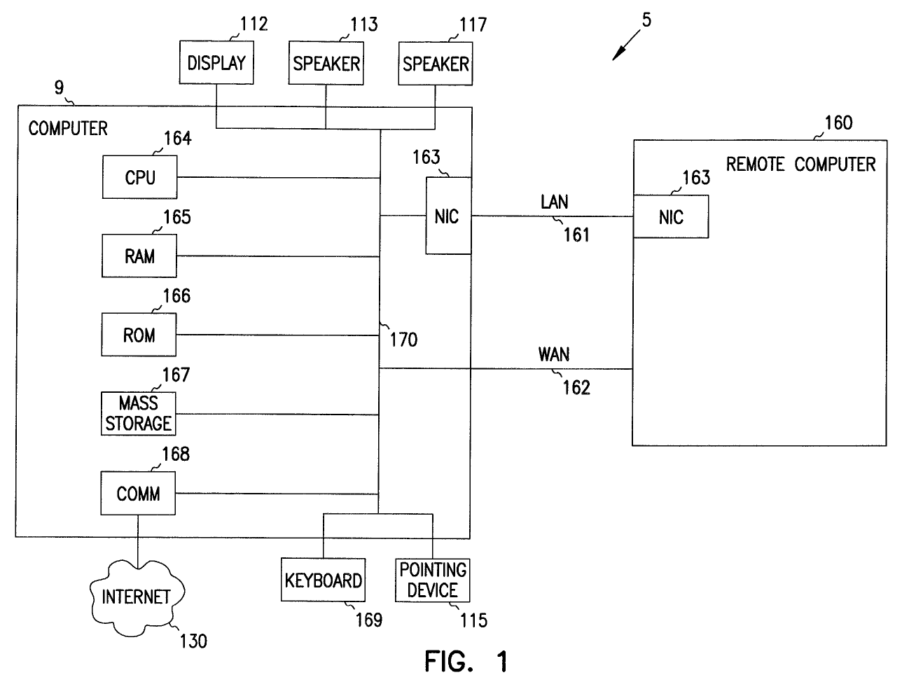

FIG. 1 is a block diagram of the hardware and operating environment 5 in which different embodiments of the invention can be practiced. The description of FIG. 1 provides an overview of computer hardware and a suitable computing environment in conjunction with which some embodiments of the present invention can be implemented. Embodiments of the present invention are described in terms of a computer executing computer-executable instructions. However, some embodiments of the present invention can be implemented entirely in computer hardware in which the computer-executable instructions are implemented in read-only memory. One embodiment of the invention can also be implemented in client/server computing environments where remote devices that are linked through a communications network perform tasks. Program modules can be located in both local and remote memory storage devices in a distributed computing environment.

Computer 9 is operatively coupled to display device 112, pointing device 115, and keyboard 169. Computer 9 includes a processor 164, commercially available from Intel®, Motorola®, Cyrix® and others, random-access memory (RAM) 165, read-only memory (ROM) 166, and one or more mass storage devices 167, and a system bus 170, that operatively couples various system components including the system memory to the processing unit 164. Mass storage devices 167 are more specifically types of nonvolatile storage media and can include a hard disk drive, a floppy disk drive, an optical disk drive, and a tape cartridge drive. The memory 165, 166, and mass storage devices 167 are types of computer-readable media. A user enters commands and information into the computer 9 through input devices such as a pointing device 115 and a keyboard 169. Other input devices (not shown) can include a microphone, joystick, game pad, satellite dish, scanner, or the like. The processor 164 executes computer programs stored on the computer-readable media. Embodiments of the present invention are not limited to any type of computer 9. In varying embodiments, computer 9 comprises a PC-compatible computer, a MacOS®-compatible computer or a UNIX®-compatible computer. The construction and operation of such computers are well known within the art.

Furthermore, computer 9 can be communicatively connected to the Internet 130 via a communication device 168. Internet 130 connectivity is well known within the art. In one embodiment, a communication device 168 is a modem that responds to communication drivers to connect to the Internet via what is known in the art as a “dial-up connection.” In another embodiment, a communication device 168 is an Ethernet® or similar hardware (network) card connected to a local-area network (LAN) that itself is connected to the Internet via what is known in the art as a “direct connection” (e.g., T1 line, etc.).

Computer 9 can be operated using at least one operating environment to provide a graphical user interface including a user-controllable pointer. Such operating environments include operating systems such as versions of the Microsoft Windows® and Apple MacOS® operating systems well-known in the art. Embodiments of the present invention are not limited to any particular operating environment, however, and the construction and use of such operating environments are well known within the art. Computer 9 can have at least one web browser application program executing within at least one operating environment, to permit users of computer 9 to access intranet or Internet world-wide-web pages as addressed by Universal Resource Locator (URL) addresses. Such browser application programs include Netscape Navigator® and Microsoft Internet Explorer®.

Display device 112 permits the display of information, including computer, video and other information, for viewing by a user of the computer. Embodiments of the present invention are not limited to any particular display device 112. Such display devices include cathode ray tube (CRT) displays (monitors), as well as flat panel displays such as liquid crystal displays (LCD's). Display device 112 is connected to the system bus 170. In addition to a monitor, computers typically include other peripheral input/output devices such as printers (not shown), speakers, pointing devices and a keyboard. Speakers 113 and 117 enable the audio output of signals. Speakers 113 and I 117 are also connected to the system bus 170. Pointing device 115 permits the control of the screen pointer provided by the graphical user interface (GUI) of operating systems such as versions of Microsoft Windows®. Embodiments of the present invention are not limited to any particular pointing device 115. Such pointing devices include mouses, touch pads, trackballs, remote controls and point sticks. Finally, keyboard 169 permits entry of textual information into computer 9, as known within the art, and embodiments of the present invention are not limited to any particular type of keyboard.

The computer 9 can operate in a networked environment using logical connections to one or more remote computers, such as remote computer 160. These logical connections are achieved by a communication device coupled to, or a part of, the computer 9. Embodiments of the present invention are not limited to a particular type of communications device. The remote computer 160 can be another computer, a server, a router, a network PC, a client, a peer device or other common network node. The logical connections depicted in FIG. 1 include a local-area network (LAN) 161 and a wide-area network (WAN) 162. Such networking environments are commonplace in offices, enterprise-wide computer networks, intranets and the Internet.

When used in a LAN-networking environment, the computer 9 and remote computer 160 are connected to the local network 161 through a network interface or adapter 163, which is one type of communications device. When used in a conventional WAN-networking environment, the computer 9 and remote computer 160 communicate with a WAN 162 through modems (not shown). The modem, which can be internal or external, is connected to the system bus 170. In a networked environment, program modules depicted relative to the computer 9, or portions thereof, can be stored in the remote memory storage device.

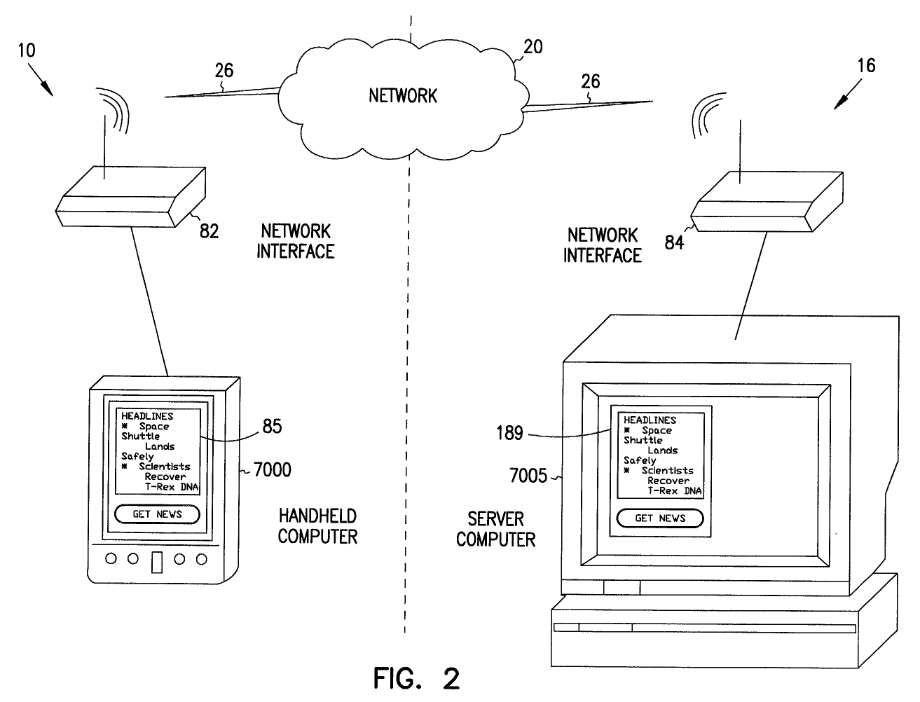

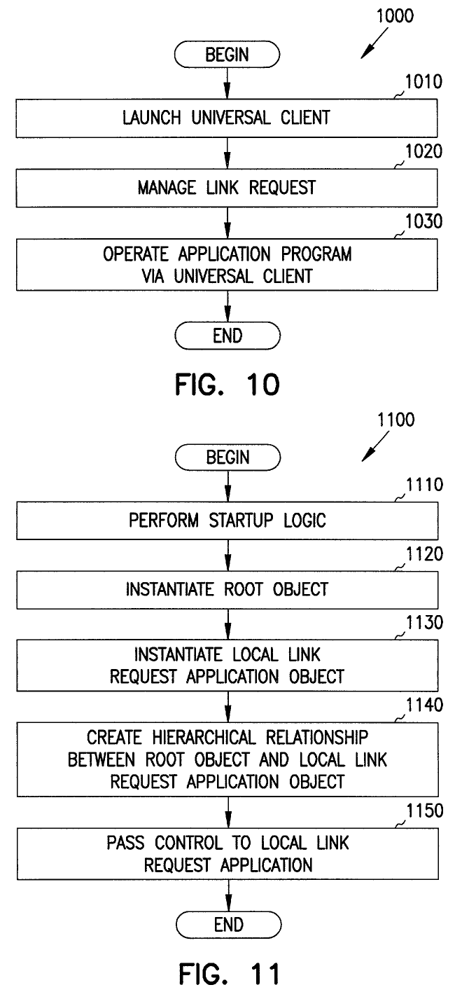

Apparatus and System Referring to FIGS. 2, 3, 4A, 4B, 5, 6, 7, 8, 9A, 9B, 9C, 9D, 9E, 9F, 9G, 9H, 9I, 9J, and 9K, a particular implementation of the invention is described in conjunction with the methods described in conjunction with FIGS. 10-29.

The following is a list of definitions of key terms and phrases used herein:

| | |
|---|---|
| Service | Any program operations or data, provided by a |
| | server system, that are accessible with a client |
| | system. |
| Server system | A computer system, usually remotely located |
| | from a user, which offers service via a client |
| | system. |
| Link request | With respect to the present invention, a message |
| | sent from a universal client program to a server |
| | program for the purpose of requesting access to |
| | some application program. Also, the process by |
| | which a universal client program establishes a |
| | network connection to a server program on a |
| | server system and requests access to an |
| | application program. |
| Server group | A network of server systems which cooperate in |
| | fulfilling link requests. |
| Client system | A computer system, usually local to the user, |
| | used to access service offered by a server |
| | system. |
| User interface | All methods of presentation between a user and |
| | a computer or program. Presentations of user |
| | input to the program include activation via |
| | voice, keyboard, and touch-screen. |
| | Presentations of program output to the user |
| | include sound, text or graphics rendered upon a |
| | visual display, and text or graphics rendered |
| | upon a printer. |
| Network | Any method and apparatus for connecting a |
| | client system to a server system allowing the |
| | exchange of digital information between the |
| | two. An example of a network connection is a |
| | transmission control protocol over Internet |
| | protocol (TCP/IP) connection over the Internet. |
| Universal client program | (a.k.a. terminal program.) The software |
| | executing on a client system used to access a |
| | service, or plurality of services. |
| Application program | (a.k.a. broadcaster, broadcasting application.) A |
| | software application that executes on a server |
| | system and provides some particular service to a |
| | client system that has activated it, via a |
| | universal client program. |
| Server program | The software, executing on a server system, |
| | used to accept requests for service from client |
| | programs. Such a request for service includes a |
| | request made to execute an application program, |
| | and to assist in establishing a connection |
| | between the client system and the application |
| | program. |
| Graphical user interface | Those aspects of a user interface involving the |
| | arrangement of pixels in a graphical display |
| | depicting graphical objects. |
| Object | As generally defined in the practice of object- |
| | oriented programming, a logical grouping of |
| | attributes and methods that has significant |
| | logical identity within an object-oriented |
| | program. The general concept of ‘attribute’ is |
| | further taught in U.S. Pat. No. 5,987,245. |
| Attribute | As generally defined in the context of object- |
| | oriented programming, any value associated |
| | with an instantiated object representing an |
| | aspect of the object's logical state. The general |
| | concept of ‘attribute’ is further taught in U.S. |
| | Pat. No. 5,987,245. |
| Method | As generally defined in the practice of object- |
| | oriented programming, any functionality |
| | associated with an instantiated object that is |
| | usually activated in response to an event. The |
| | concept of ‘method’ is further taught in U.S. |
| | Pat. No. 5,987,245. |
| Event | As generally defined in the practice of object- |
| | oriented programming, a signal or message to a |
| | program, targeted to a particular object, which |
| | typically results in the invocation of a method of |
| | the target object. The concept of ‘event’ is |
| | further taught in U.S. Pat. No. 5,987,245. |
| Event-driven system | As generally defined in the practice of object- |
| | oriented programming, the idea that actions or |
| | methods are invoked within a program in |
| | response to events, and that program |
| | functioning occurs as a result of objects |
| | responding to events, and also from methods |
| | passing messages to other objects. The concept |
| | of ‘event-driven system’ is further taught in |
| | U.S. Pat. No. 5,987,245. |
| User interface object | (provisionally referred to as “graphical objects”) |
| | A logical object, associated with some aspect of |
| | a user interface. Examples include a graphical |
| | button object, a graphical text input/output |
| | control object (i.e. an “single line edit” control |
| | object), and a serial communications object. A |
| | user interface object may be a composition of |
| | user interface objects. |
| Simple UT object | (provisionally referred to as “primordial |
| | graphical object”) Any simple user interface |
| | object not composed of other user interface |
| | objects. |
| Composite UI object | Any user interface object composed of more |
| | than one component user interface object. |
| Graphical object | A sub-class of user interface objects associated |
| | with some region of a graphical user interface, |
| | the arrangement of pixels therein denoting, |
| | signifying or otherwise conveying meaning |
| | about some aspect of program operation. |
| | Certain graphical objects are intended to be the |
| | target region for certain input events. For |
| | example, a button object is intended to be the |
| | target of click or tap events, and a text input |
| | object is intended to be the target for keystroke |
| | events generated from a keyboard. |
| Local input device | Any integrated or peripheral input device |
| | connected to a computer system, as |
| | distinguished from such devices connected via a |
| | network connection. |
| User input device | Any local input device that can be physically |
| | operated by a user. Examples include a mouse, |
| | a keyboard, and a microphone. |
| Local input event | Any event or signal sent to a program from any |
| | input device connected to the computer system |
| | within which the program is executing. |
| User input event | Any local input event originating from the |
| | operation of a user input device. |
| Protocol event | Any event or signal, received by any software of |
| | the present invention, that requires proper |
| | notification be made to some associated |
| | software of the present invention. An example |
| | of a protocol event is a character keyed on a |
| | client system and then sent to an application |
| | running on a server system. A further example |
| | of a protocol event is the creation of a new |
| | graphical user interface object within an |
| | application program, executing on a server that |
| | is sent to universal client software such that a |
| | representation thereof may be rendered upon the |
| | client system. |
| Protocol message | A representation of a protocol event as it is |
| | actually communicated between client and |
| | server. |
| Universal object logic | (a.k.a. remote object logic, object definition |
| | library) Any program operation, activated by a |
| | local input event targeted to some object, which |
| | occurs independently of any subsequent server |
| | application operations that may result from |
| | transmitting knowledge of the local input event |
| | to the server application. The server |
| | application, upon subsequently receiving |
| | notification of the local input event from the |
| | client, may correctly assume that such |
| | operations have been executed upon the client |
| | eliminating the need for the server application to |
| | instruct the client to perform those operations. |
| | For example, if a user taps a graphical button |
| | object the button will flash in the client software |
| | without being told to do so by the server |
| | application. The server application simply |
| | assumes the client software has attended to this |
| | feedback effect locally. |
| Instant attribute | Any attribute of a user interface object that, |
| | when modified by programmatic logic within an |
| | application program, automatically has the |
| | change communicated to an associated user |
| | interface object existing in the client program. |
| | For example, with respect to many graphical |
| | objects, attributes including X coordinate, Y |
| | coordinate, width, and height, and background |
| | color, foreground color, border style, text |
| | content, text color and text style are all |
| | implemented as instant attributes. |
| Application programmatic logic | (a.k.a. programmatic logic, application logic) |
| | All operations of an application program not |
| | comprising universal object logic. This includes |
| | all logic defined in a server application |
| | comprising the service offered by that |
| | application. |
| Session | The operation of a server-side application |
| | program one time by a single user via the |
| | universal client software of the present |
| | invention. |
| Shared state | (a.k.a. shared state hierarchy.) The hierarchy of |
| | object-oriented data synchronously maintained |
| | during a session in both the universal client |
| | program and the application program. |

With reference to FIG. 2, in an embodiment of client/server system that includes client system 10. Examples of client system 10 include a desktop computer, a portable computer, a laptop computer, a personal digital assistant (PDA) such as a PALMS handheld device, a Windows CE® device, or an IP-telephone. Client 10 includes a handheld computer 7000 in communication with a client-side wireless modem 82 providing network connection 26 through a bi-directional communication network 20. Network 20 broadly comprises any system that facilitates the transmission of digital data between two devices. Such a channel may involve any combination of transmission technologies including electronic stages, photonic stages, digital stages, and analog stages. One embodiment of a photonic transmission is personal area networking technology, such as a Bluetooth® compliant network.

One embodiment of the bi-directional communications network 20 is a TCP/IP network, such as the Internet or corporate Intranet. Another embodiment of the bi-directional communications network 20 is a network implementing an ordered packet protocol layered upon an unordered packet protocol layer, such as a user datagram protocol over Internet protocol (UDP/IP).

Server system 16 includes a server-side wireless modem 84 in connection with a server computer 7005. Server system 16 may be any computer system that can be operatively connected to bi-directional communication network 20 and that is capable of supporting an operating system such as Microsoft NT® or LINUX. An exemplary server system 16 is a PowerEdge® 4400, available from Dell Computer Corporation®, headquartered in Round Rock, Tex.

Wireless modems 82 and 84 serve as network interfaces for providing a TCP/IP or UDP/IP connection from handheld computer 7000 through Internet 20 to server computer 7005.

User interface 85 shown on handheld computer 7000 is the user interface controlling application program 189 shown running on server computer 7005. User interface 85 is graphically rendered by a universal client program running on the handheld computer 7000. The universal client program of the present invention is subsequently described herein. Application program 189 is shown running on server computer 7005. In an embodiment the graphical user interface (GUI) is rendered on the monitor of server computer 7005. In another preferred embodiment the application program 189 running on the server computer would not simultaneously display a GUI on the monitor of server computer 7005. In either of these embodiments the effect and operation of the application program for the user of handheld computer 7000 is identical.

One aspect of the invention is an optimized protocol that substantially minimizes the required bandwidth between server system 16 and client system 10; by efficiently maintaining shared state, protocol events can be minimally represented at a high level of abstraction using protocol messages. This is important because the bandwidth provided by early generation networks 20 is limited and costly, and because bandwidth unconsumed by protocol is available for application content.

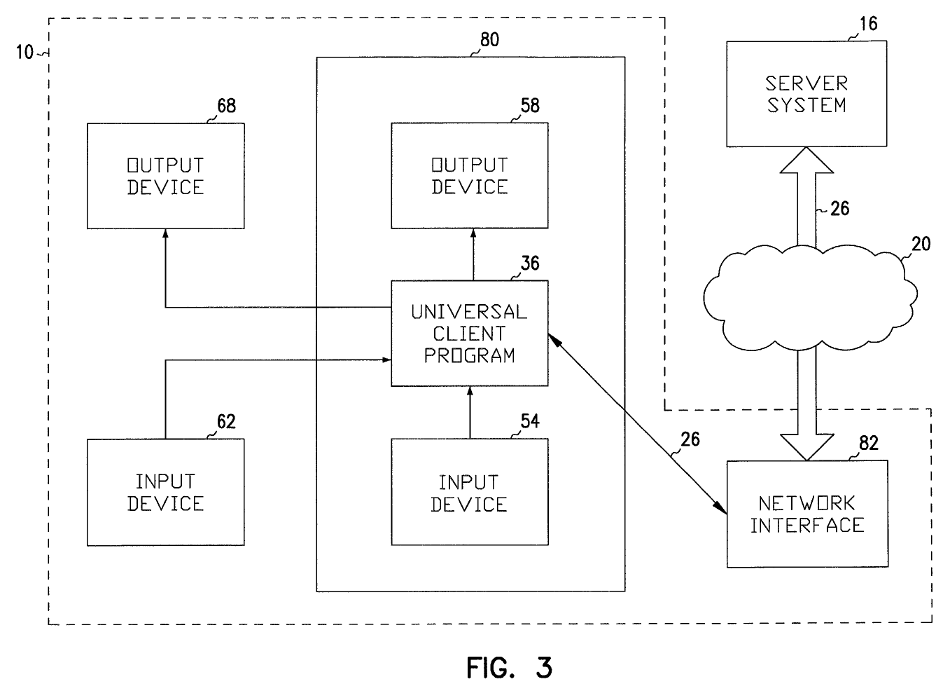

With reference now to FIG. 3, client system 10 includes universal client program 36 executing on remote computer 80 and a network connection 26 provided by network interface 82 through bi-directional communication network 20 to server system 16. Remote computer 80 is any computing device capable of executing universal client program 36. An exemplary remote computer is a Palm V handheld available from Palm Inc, 5470 Great America Parkway, Santa Clara, Calif.

Universal client program 36 facilitates one or more sessions, sends locally-generated protocol events to the server via protocol messages, responds to server-generated protocol events received as protocol messages, and maintains shared state.

With continuing reference to FIG. 3, client system 10 optionally includes one or more of the following: an internal input device 54, such as a touch sensitive stylus pad, an internal output device 58, such as an LCD display screen, an external input device 62, such as an attachable keyboard or microphone, and an external output device 68, such as a printer.

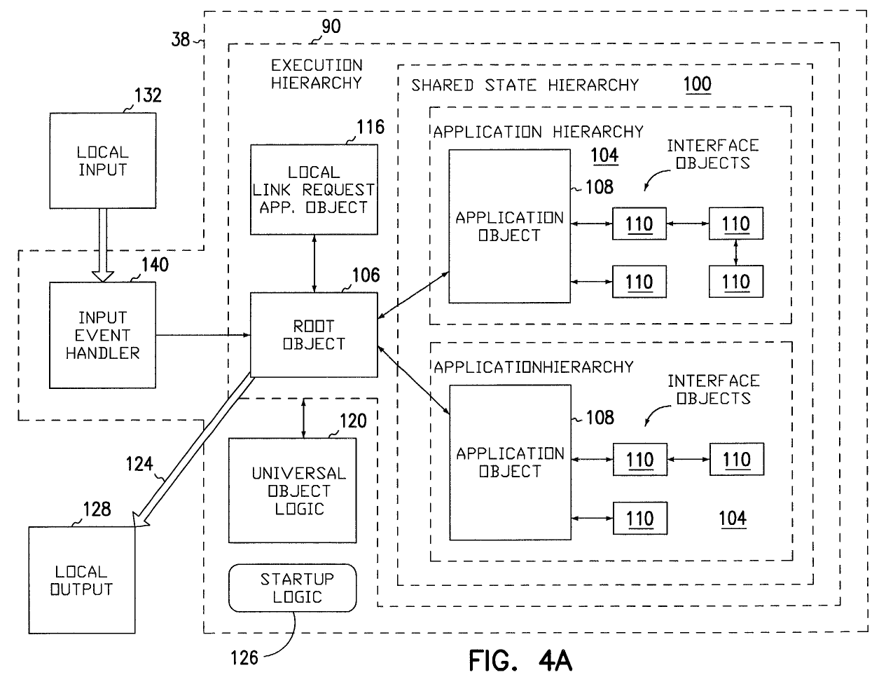

With reference now to FIG. 4A, universal client executive 38 comprises execution hierarchy 90, universal object logic 120, startup logic 126, and input event handler 140. Execution hierarchy 90 is a data structure containing various objects created dynamically within universal client executive 38; it comprises shared state hierarchy 100, root object 106, and local link request application object 116. Shared state hierarchy 100 contains all application hierarchies 104 associated with corresponding sessions. When the universal client program is executed, startup logic 126 executes once thereby creating universal client program executive 38, and performs various initialization operations including creating local link request application object 116 and root object 106.

Local link request application 116 is used to initiate new sessions. An embodiment presents a GUI with which a user may initiate a link request by specifying an IP address or domain name associated with a server and the file name of an application program available in the persistent storage of that server.

An application hierarchy 104 comprises an application object 108 and a plurality of user interface objects 110.

Root object 106 is the parent object for all application objects 108 in execution hierarchy 90. Input event handler 140 receives input events and manages the sending of protocol events to the appropriate objects within the appropriate application hierarchy 104 via root object 106. The appropriate application hierarchy is partially determined by root object 106, which distinguishes one application hierarchy as being active such that it is the preferred target for input events.

Application object 108, the primary object responsible for maintaining the shared state of a single session, comprises exemplary structure and connectivity necessary to facilitate a session. It is shown in communication with root object 106 and user interface objects 110. User interface objects 110 include graphical objects such as windows, buttons, text fields, and icons.

Universal object logic 120 comprises object-oriented methods to create, destroy, and manage application objects 108 and associated user interface objects 110. Universal object logic 120 is shown in connection with execution hierarchy 90, which is a logical grouping of objects; it should be understood that universal object logic 90 is a collection of methods that are accessed extensively by all objects within execution hierarchy 90.

Local input 132 is any message or signal generated by any hardware unit in the client system. Input event handler 140 receives local input events from local input 132 and coordinates communication of each local input event to root object 106, some application object 108, or some user interface object 110.

With continuing reference to FIG. 4A, there is shown the production 124 of local output 128 from execution hierarchy 90. This represents the potential for objects within the execution hierarchy 90 to effect local output to local output devices of the client system, including liquid crystal displays, printers, hard drives, infrared ports, or audio speakers.

With reference now to FIG. 4B, there is shown a simplified universal client executive 180 capable of operating a single application program via a single session. Simplified universal client executive 180 comprises execution hierarchy 90, universal object logic 120, startup logic 181, and input event handler 140. Execution hierarchy 90 comprises a single shared state hierarchy 100. Shown within shared state hierarchy 100 is a single application hierarchy 104. Within application hierarchy 104 there is shown an application object 108 and a plurality of user interface objects 110. Execution hierarchy 90, shared state hierarchy 100, and application hierarchy 104 represent logical groupings of objects as they are similarly grouped in FIG. 4A. When the simplified universal client program executes, startup logic 126 executes once, thereby creating simplified universal program executive 180, and performs various initialization operations including initiating a link request directly without utilizing a local link request application as described and shown in FIG. 4A.

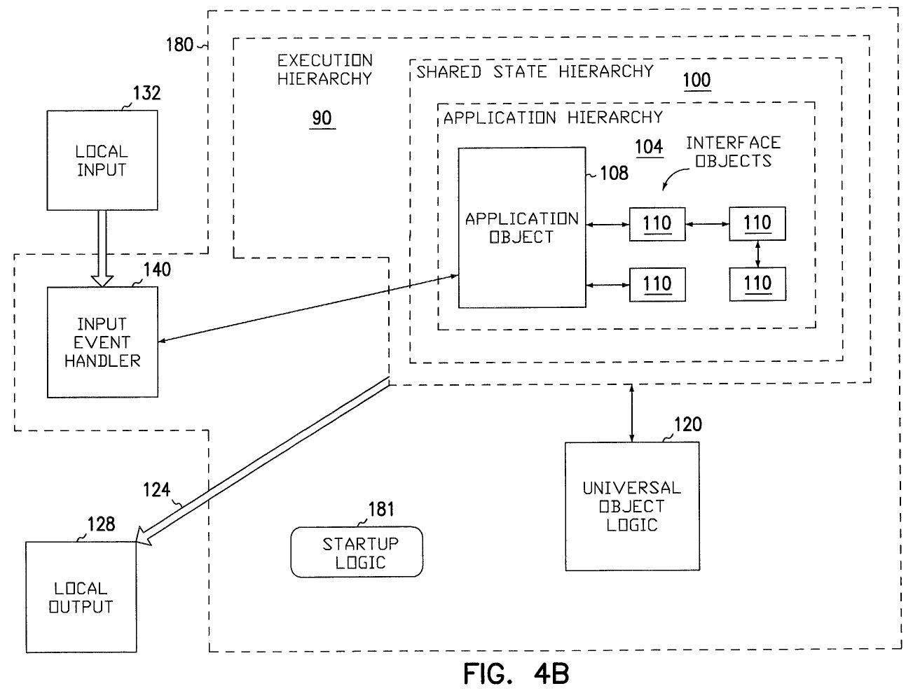

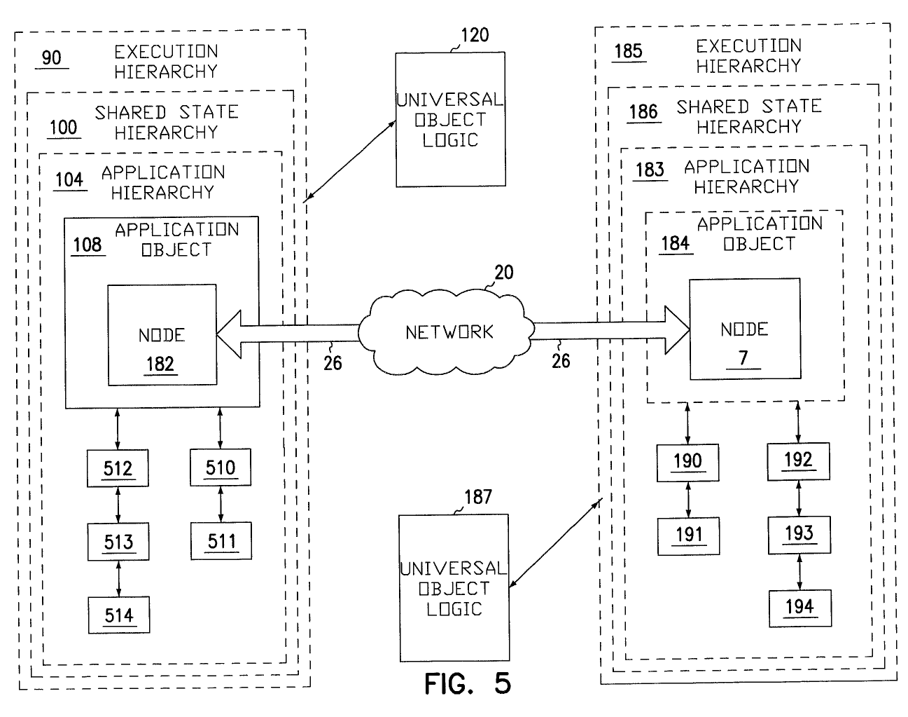

With reference now to FIG. 5, there are shown three logical groupings: execution hierarchy 90, shared state hierarchy 100 and application hierarchy 104; these groupings are also shown on FIGS. 4A and 4B. Application hierarchy 104 comprises application object 108 and various associated user interface objects 510-514. Application object 108 comprises a node 182 used to send and receive secure communication of protocol messages to some other single associated node 7 existing within an associated application object 184 in an associated application hierarchy 183. Universal object logic 120 is used to translate incoming protocol messages into local protocol events, and by the application object 108 and associated interface objects 510-515 to translate local protocol events into outgoing protocol messages. Network connection 26 is shown connecting node 7 to node 182 via network 20. One embodiment of network connection 26, used by nodes 7 and 182 to exchange protocol messages, is a TCP/IP connection. Another embodiment of network connection 26, used by nodes 7 and 182 to exchange protocol messages, is a UDP/IP connection. An embodiment of network 20 is the Internet. In a preferred embodiment, universal object logic 120 and 187 comprise logically identical code segment libraries.

With further reference FIG. 5, there are shown three logical groupings that parallel the previously discussed groupings in FIG. 5: the execution hierarchy 185, shared state hierarchy 186 and application hierarchy 183; these grouping are also shown on FIGS. 4A and 4B. Application hierarchy 183 comprises an application object 184 and various associated user interface objects 190-194. Application object 184 comprises a node 7 used to send and receive secure communication of protocol messages to some other single associated node 182 existing within an associated application object 108 in an associated application hierarchy 104. Universal object logic 187 is used by the application object 184 and associated interface objects 190-195 to translate local protocol events into outgoing protocol messages, and to translate incoming protocol messages into local protocol events. Network connection 26 is shown connecting node 7 to node 182 via network 20. An embodiment of network connection 26, used by nodes 7 and 182 to exchange protocol messages, is a TCP/IP connection. Another embodiment of network connection 26, used by nodes 7 and 182 to exchange protocol messages, is a UDP/IP connection. An embodiment of network 20 is the Internet.

With continuing reference to FIG. 5, there are shown application hierarchies 183 and 104 in synchronization with respect to the objects contained each therein. The form and purpose of this synchronization, as maintained by the proper exchange of protocol messages, comprises a novel aspect of the present invention.

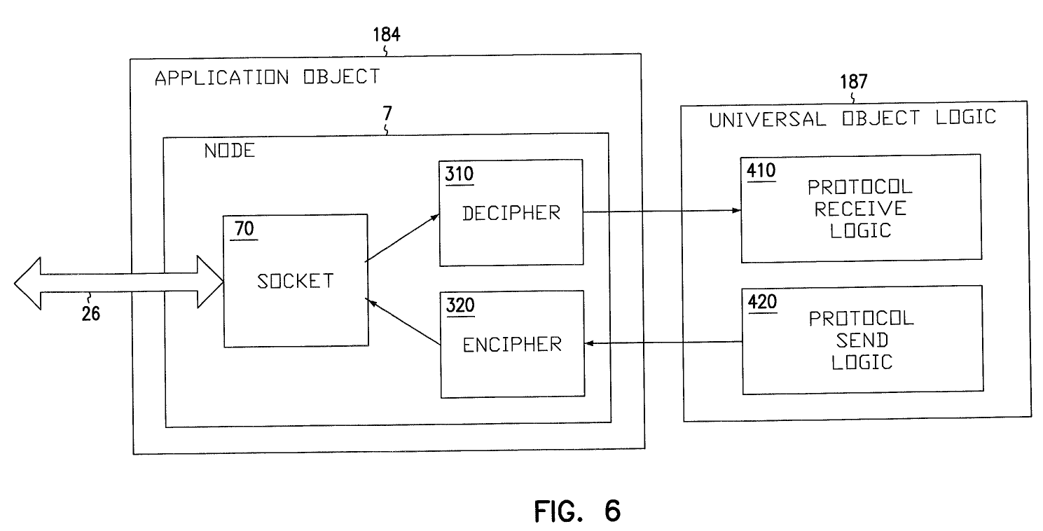

With reference now to FIG. 6, there is shown an application object 184 comprising node 7 and universal object logic 187. Node 7 comprises a socket 70, decipher 310, and encipher 320. Universal object logic 187 includes protocol receive logic 410 and protocol send logic 420. Socket 70 here is shown to be that component of node 7 in direct communication with a corresponding socket in an associated node. An embodiment of socket 70 is a Berkeley standard socket over TCP/IP. Another embodiment of socket 70 is a socket over UDP/IP. Decipher 310 and encipher 320 jointly comprise a mechanism for encrypting and decrypting protocol messages. An embodiment of decipher 310 and encipher 320 is a well-known stream cipher such as a hybrid LCSR/LFSR stream cipher initialized with a key created using a well-known public key exchange scheme such as Diffie-Hellman key exchange.

Protocol receive logic 410 interprets incoming protocol messages and calls appropriate methods of objects in the execution hierarchy. Protocol send logic 420 converts protocol events triggered by methods of objects in the execution hierarchy into outgoing protocol messages.

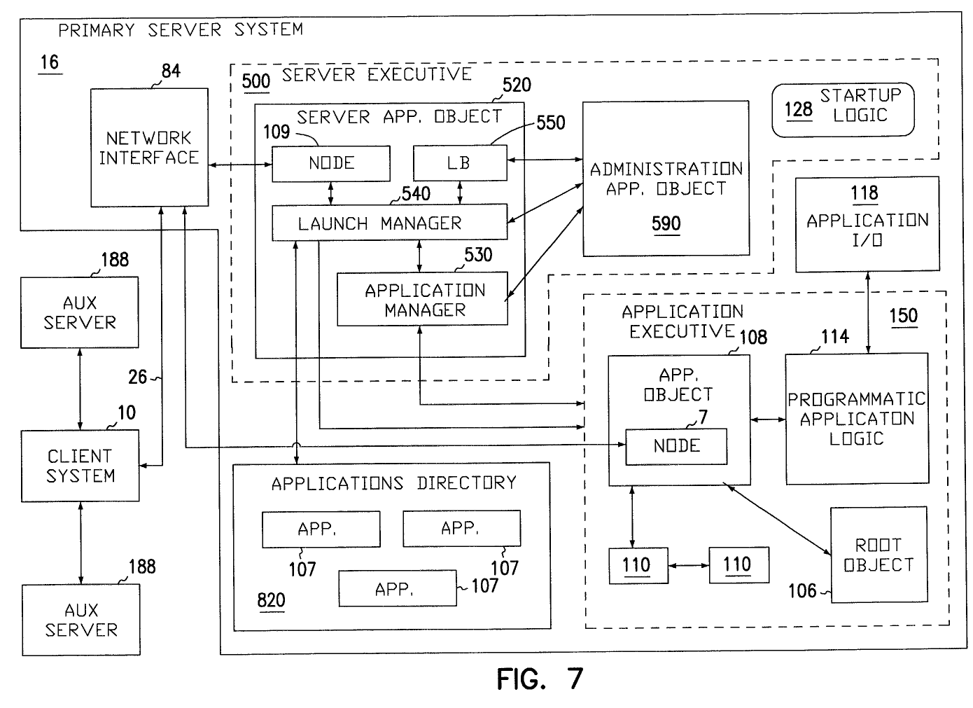

With reference now to FIG. 7, a server group comprises a primary server system 16 and zero or more auxiliary servers 188, two of which are depicted. Auxiliary servers 188 are architecturally similar to the primary server 16. Client system 10 is not part of the server group, but is depicted for clarity. A server group cooperatively fulfills link requests.

A server system such as primary server system 16 comprises a network interface 84, zero or more application executives 150, application I/O 118, server executive 500, and applications directory 820. Applications directory 820 is typically a persistent file store containing a plurality of named application programs 107 which can be accessed via link requests from a client system 10. An application executive 150, created when an application program 107 is launched, contains application object 108 containing node 7 connecting to an associated node in client 10 via the network interface 84. Network interface 84 is shown in connection with client system 10 via network connection 26.

The server executive 500 comprises startup logic 128, the server application object 520, and administration application object 590. The server application 520 contains a node 109, application manager 530, launch manager 540, and load balancer 550. The administration application object 590 can modify the behavior of the launch manager 540, and load balancer 550, and can monitor and modify the state of application executives 150 via the application manager 530.

With continuing reference to FIG. 7, a link request message may be sent via the network interface 84 to the node 109 of the server application object 520. The node 109 sends a message to the launch manager 540 requesting that a particular application be executed. The launch manager consults the load balancer 550 for permission to launch the requested application on the primary server system 16. The load balancer 550 may either permit or deny the launch. In the case of a denied launch, the load balancer 550 sends a reply to the launch manager 540 with alternative link request information containing the address of an auxiliary server 188 and the launch manager will communicate this information to client system 10 which may then issue a new link request to this alternative server. In the case of an accepted launch, the load balancer 550 replies affirmatively to launch manager 540 which then launches an application 107 from the applications directory 820 creating an application executive 150; finally it notifies application manager 530 of the successful launch.

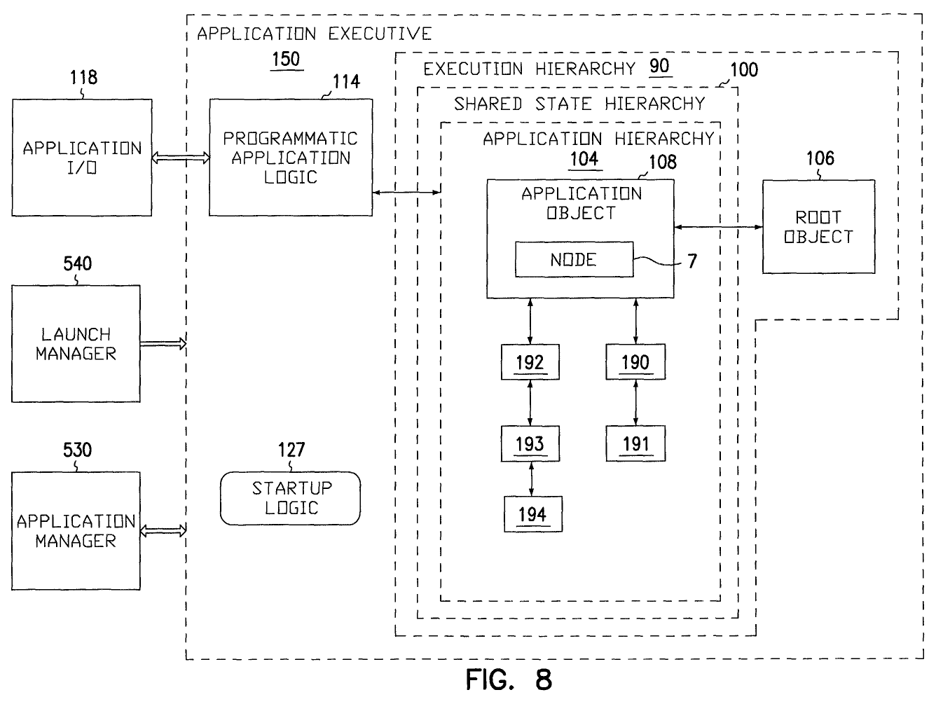

Application executive 150, detailed in FIG. 8, comprises root object 106, application object 108, various user interface objects 110, and programmatic application logic 114.

With reference now to FIG. 8, there is shown an application program as executing in an application executive 150 comprising execution hierarchy 90, programmatic application logic 114, and startup logic 127. Execution hierarchy 90 comprises root object 106 and the shared state hierarchy 100, a logical grouping of objects. Shared state hierarchy 100 encapsulates application hierarchy 104, another logical grouping of objects. Application hierarchy 104 comprises application object 108 and a plurality of user interface objects 510-514. Shown within application object 108 is a node 7.

Programmatic application logic 114 is shown in connection with application hierarchy 104; it comprises all logic defining the service provided by the application including instructions for handling user input events and for updating user interface objects. An example of programmatic application logic is the functionality providing an e-mail service, including retrieving e-mail messages from an e-mail server, and displaying the e-mail messages upon the GUI of a client system using the user interface objects provided by a universal client program.

Programmatic application logic 114 is shown to be capable of accepting and producing application I/O 118. An example of application input would be programmatic application logic receiving e-mail messages stored on some connected e-mail server. An example of application output might be sending a newly user-composed e-mail message to an e-mail server system.

With continuing reference to FIG. 8, application manager 530 is a facility residing within the server program as referenced in FIG. 7 and described previously. Application manager 530 uses native operating services to monitor the execution of application executive 150, and determine various status information for purposes of system administration. Objects within application executive 150 may also provide certain data to application manager 530 including execution state and networking statistics. Application manager 530 may alter the execution state of application executive 150; such alteration might include forced termination or notification of a global server event.

Launch manager 540 is a facility residing with the server program as referenced in FIG. 7 and described previously. Launch manager 540 is responsible for creating and initializing application executive 150, and provides certain launch data to the application executive. Typical launch data in an embodiment includes initial parameters and network connection data, including a TCP/IP or UDP/IP socket instance.

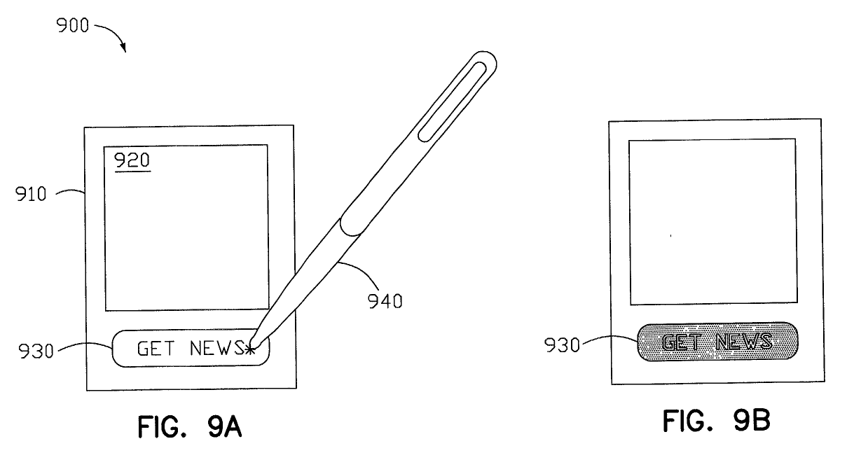

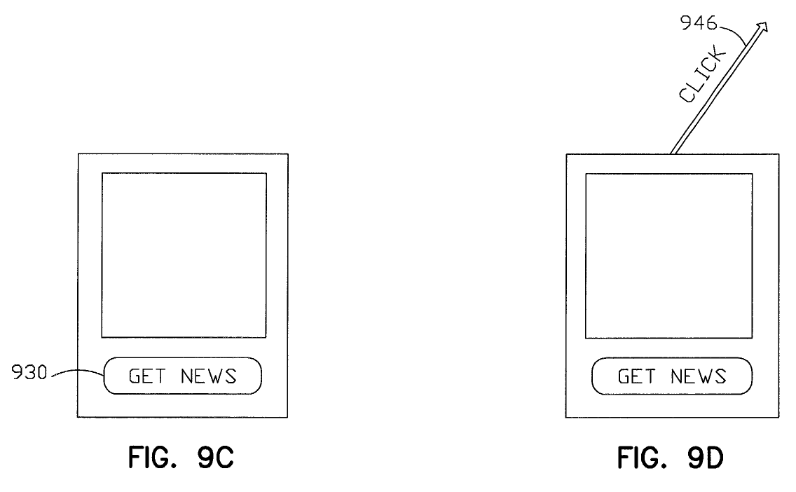

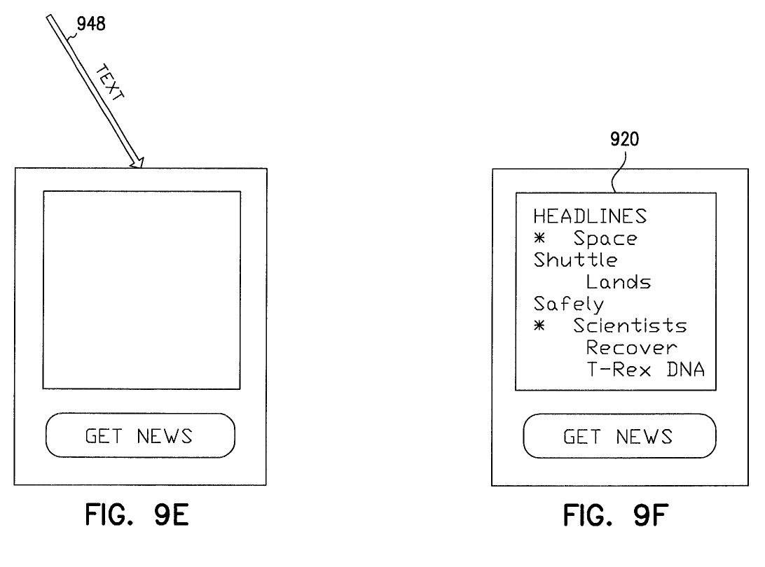

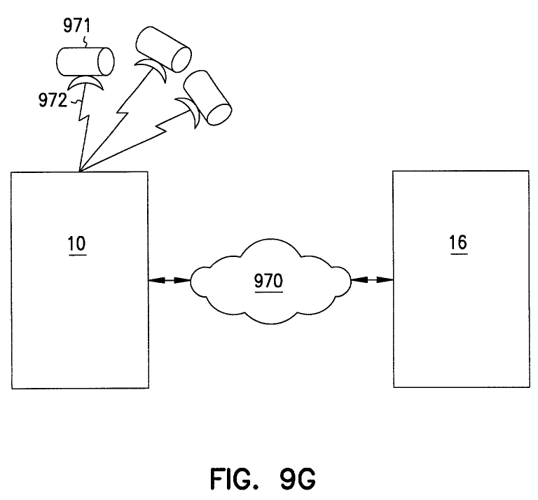

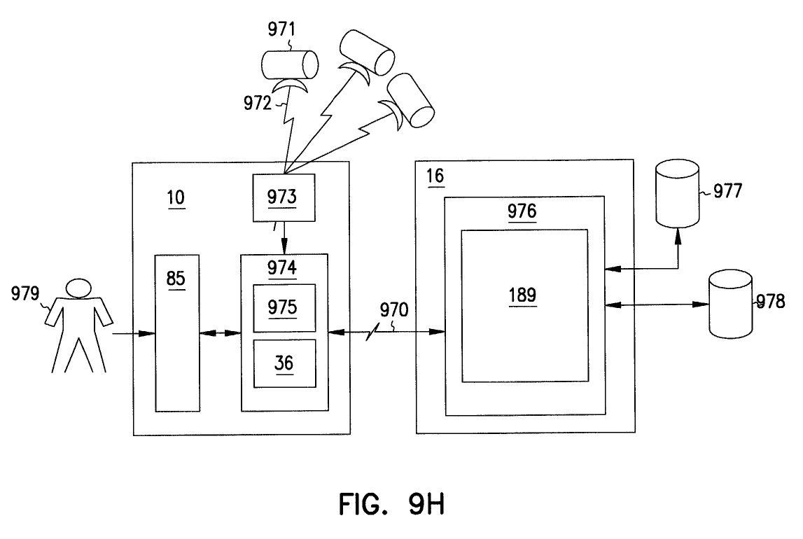

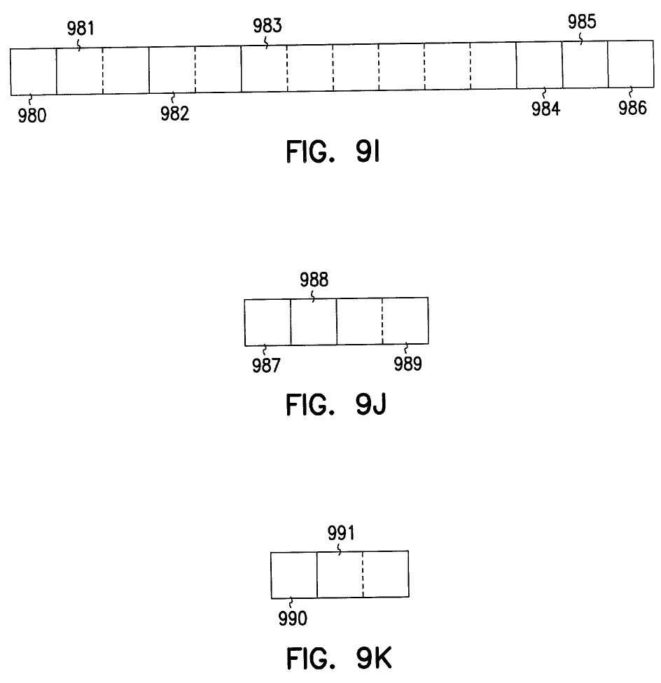

The sequence of FIGS. 9A-9F illustrates the distinction between universal object logic and programmatic application logic.

With reference now to FIG. 9A, there is shown a GUI 900 rendered upon a tap-sensitive display unit 910 comprising two GUI objects: multi-line text field 920, and button 930. GUI objects 920 and 930, are rendered by a universal client program of the present invention executing on the computer device into which a tap-sensitive display unit 910 is integrated. There is shown stylus 940 in physical contact with the surface of tap-sensitive display unit 910 in the region of the display in which button 930 is displayed. The effect of such contact is to trigger a ‘click’ event associated with button 930.

With reference now to FIG. 9B, there is shown the GUI referenced in FIG. 9A, as it would appear immediately after the click event has been triggered for button 930. Here the universal client program has provided immediate visual feedback to the user that the button was clicked by changing the appearance of the button from black text on a white background to white text on a black background. It is important to note that this visual effect is performed before the universal client software sends any notification of the click event to the application program running remotely on a server system.

With reference now to FIG. 9C, there is shown the GUI referenced in FIGS. 9A and 9B. Here button 930 has immediately returned to the appearance it had in FIG. 9A. The effect achieved by the sequence of FIGS. 9B and 9C is that button will appear to ‘flash’ when it has been clicked. The visual effects produced in FIGS. 9B and 9C do not depend on any communication with the application program running remotely on a server system. The universal client program via universal object logic achieves these effects independently. Universal object logic in contrast to programmatic application logic is further described herein.

With reference now to FIG. 9D, there is again shown the GUI referenced in FIGS. 9A through 9C. Further shown is the transmission of click protocol message 946 produced by the stylus tap described for FIG. 9A being transmitted from the universal client software to the application program running remotely on a server system. This click message will trigger certain programmatic application logic in the application.

With reference now to FIG. 9E, there is again shown the GUI referenced in FIGS. 9A through 9D. Further shown is a text update protocol message 948 from the remotely running application program being received by the universal client software. The text update message is sent by certain programmatic application logic that was activated by the click protocol message previously shown to have been sent in FIG. 9D.

With reference not to FIG. 9F, there is again shown the GUI reference in FIGS. 9A through 9E. Further shown is text now displayed in multi-line text field 920 comprising the text sent from the application program running on the server, which was contained in the text update protocol message reference in FIG. 9E.

### Method of Operation/Detailed Description of Preferred Embodiments

Server Program Launch and Initialization

The server program exists as a binary executable image in the persistent storage of a server system and is executed by well known methods creating a server executive 500, as follows:

1. Execute startup logic 128.

2. Startup logic 128 instantiates server application object 520. In the preferred embodiment, this and following objects are instantiations of C++ classes.

3. Load balancer 550 is instantiated as a member of server application object 520.

4. Application manager 530 is instantiated as a member of server application object 520.

5. Launch manager 540 is instantiated as a member of server application object 520.

6. Node 109 is instantiated as a member of server application object 520.

7. Decipher 310 and encipher 320 are instantiated as a members of node 109.

8. Socket 70 is instantiated as a member of node 109.

9. Startup logic 128 instantiates administration application object 590.

10. Startup logic 128 starts an independent thread of execution within server executive 500; this thread waits for input on socket 70 from network interface 84.

Universal Client Program Launch and Initialization

In an embodiment, the universal client program exists as a binary executable image in the persistent storage of a client system and is executed by well known methods creating a universal client executive 36, as follows:

1. Execute startup logic 126.

2. Startup logic 126 instantiates root object 106.

3. Startup logic 126 instantiates local link request application object 116 and creates a hierarchical relation between root object 106 and local link request application object 116.

4. Control is passed to local link request application object 116 to accept user input and generate a link request.

The terms “protocol message” and “protocol event” have been introduced previously, but some additional clarification may prove helpful. As defined, a “protocol message” is a high-level message sent between the client system and the server system, in either direction. A protocol message encodes and thereby represents a “protocol event” that has happened on either system which requires that the other system be notified. For example, on the client system the user may click a mouse. The universal client program recognizes that this local input event is a protocol event and encodes this event into a “CT_Click” protocol message, which is then transmitted to the application program on the server. The application program receives this “CT_Click” protocol message, decodes it, and generates a “SR_Click” protocol event within the application program.

There are four prefixes that are used: “CT”, “ST”, “CR”, and “SR”; these respectively denote “client transmit”, “server transmit”, “client receive”, and “server receive”. The two ‘transmit’ prefixes denote protocol messages. The two ‘receive’ prefixes denote corresponding protocol events that are decoded by the recipient of the protocol messages.

Generating and Handling a Link Request

1. Local link request application object 116 accepts user input in the form of a URL. For example, the following user specifies a server system identified by IP address “192.168.42.127” and an application program resident on that server system by the name “news.exe”:

map://192.168.42.127/news.exe

In one preferred embodiment the prefix “map://” is an abbreviated reference to “mobile application protocol”, which is included as a term that refers to the novel high-level protocol particular to the present invention. Such a prefix is used to distinguish the protocol requested according to well-known conventions of URL formation (i.e. “telnet://” or “http://”).

2. Local link request application instantiates an application object 108.

3. A node 182 is instantiated as a member of application object 108.

4. Socket 70 is instantiated as a member of node 182.

5. Decipher 310 and encipher 320 are instantiated as member of node 182. At this point, these two stream ciphers are disabled such that data passed through them will not be encrypted.

6. A TCP/IP or UDP/IP connection is established between socket 70 and the socket belonging the node 109 of the server program, which is ‘listening’ for incoming connection requests. The IP address of the server is obtained by parsing the user specified URL referenced in action 1.

7. A high-level protocol message called “ST_Connect” is sent from the server program to the universal client program (to affirm that a TCP/IP or UDP/IP connection is successfully established).

8. The universal client program receives the “ST_Connect” message sent from the server program, which causes a “CR_Connect” protocol event within the universal client program.

9. The “CR_Connect” protocol event causes the universal client program to send a “CT_Link Request” protocol message to the server program. This protocol message contains the user specified URL referenced in action 1.

10. The server program receives the “CT_Link_Request” protocol message and a “SR_Link_Request” protocol event is generated in the server program.

11. Launch manager 540 handles the “SR_Link_Request” protocol event by parsing the user specified URL information encoded in the “CT_Link_Request” protocol message.

12. Launch manager 540 determines if the requested application program is available on the server system. If it is not available then the launch manager transmits a “ST_FileNotFound” protocol message to the client, informing the client that the requested application program is unavailable.

13. If the requested application program is available, the launch manager informs load balancer 550 of the application program launch request, and waits for a response from load balancer 550.

14. Load balancer 550 analyzes the state of the server system and issues one of three possible responses to the launch manager 540: (a) launch denied, (b) launch approved, or (c) connect to an alternate server.

15. In case (a) the load balancer 550 determines that server resources are fully utilized, and that no auxiliary server system is available as an alternative. Load balancer 550 sends a “launch denied” response to the launch manager 540. Launch manager 540 then sends a “ST LaunchDenied” protocol message to the client system.

16. In case (b) of action 14 the load balancer 550 determines that there are sufficient unused server resources to support the requested application program. Load balancer 550 sends a “launch approved” response to the launch manager 540. Launch manager 540 then proceeds to launch the application program as described below in “Application Program Launch and Initialization”.

17. In case (c) of action 14 the load balancer 550 determines, as in case (a), that server resources are fully utilized. However, in this case the load balancer is configured with knowledge that one or more auxiliary servers are available to fulfill the link request. Load balancer 550 selects an auxiliary server from among the available auxiliary servers and sends an “instruct client to try auxiliary server” response to launch manager 540. Launch manager 540 then composes a new URL substituting the IP address of the auxiliary server, provided by load balancer 550, in place of the IP address of the primary server system originally provided by the client in the “CT_Link_Request” URL. Launch manager then transmits this newly composed URL via a “ST_LinkURL” protocol message to the client system.

Application Program Launch and Initialization

In an embodiment, the application program exists as a binary executable image in the persistent storage of a server system and is executed by operating system services creating an application executive 150, as follows:

1. Launch manager 540, having previously verified that the requested application program 107 resides in applications directory 820, uses well known operating system methods to launch the requested application, thereby creating an application executive 150.

2. Certain information is passed to the newly created application executive by well-known methods; this information includes client system specifications, which were transmitted to the server as part of the “CT_Link_Request” protocol message, and information that permits the newly launched application program to connect to the universal client program. In an embodiment, a reference to socket 70 is passed to the application as a command line parameter; in another embodiment it might be passed via a shared memory technique.

3. Startup logic 127 executes as control is passed to the application program.

4. Startup logic 127 instantiates root object 106 and application object 108; then startup logic creates a hierarchical relation between root object 106 and application object 108.

5. A node 7 is instantiated as a member of application object 108.

6. Socket 70 is instantiated as a member of node 7 and initialized using the information passed to the application from launch manager 540.

7. The stream ciphers within node 7 of the universal client program and node 7 of the application program are initialized so that all subsequent protocol communications are encrypted. In an embodiment this initialization is achieved by a well-known method called Diffie-Hellman public key exchange.

8. Startup logic 127 passes control to programmatic application logic 114.

Application Program Operation via Universal Client Program

### EXAMPLE 1

Creation of GUI Objects

Startup logic 127 passes control to programmatic application logic 114 by triggering an initial event called “OnStartup”. At this point an application will usually create some number of GUI objects, which will allow the user to trigger subsequent programmatic application logic operations. The following actions comprise the creation of a GUI button object:

1. The application program encodes a protocol message called “ST_CreateVisualobject” with certain parameters including the type of visual object to be created (i.e. Button) and the initial values of the attribute of that visual object. For a button object the specified initial attributes include the (X,Y) coordinate values specifying a point on a display unit in relation to which the button object will be rendered, the height and width of the button, the style of the button (i.e. square corners, rounded comers, etc.), the background color of the button, the color of the border of the button, the text displayed as the label of the button, the style of that text, and the color of that text.

The methods by which an application program encodes parameters and attribute values are well known and primarily trivial. An embodiment uses well-known methods of compression to further reduce the number of bytes transmitted. A novel aspect of the present invention is rather that the number of (as opposed to the size of) protocol messages exchanged during a session are minimized due to the availability of universal object logic; universal object logic allows certain fundamental operations to occur within both the universal client program and the application program independently, eliminating the need to coordinate these fundamental operations with additional protocol messages.

2. The application program transmits this “ST_CreateVisualobject” protocol message to the client.

3. The universal client program receives this “ST_CreateVisualobject” protocol message and a “CR_CreateVisualobject” protocol event is triggered.

4. A method in the universal object logic handles the “CR_CreateVisualobject” protocol event and decodes the parameters and attributes sent from the application program.

5. Universal object logic instantiates a button user interface object 110 within the application hierarchy 104 containing the application object 108 whose node 7 received the “ST_CreateVisualobject” protocol message.

6. This new button object is placed in hierarchical relation to either application object 108 or to some other previously instantiated object within application hierarchy 104. A parameter encoded within the “ST_CreateVisualobject” protocol message identifies which previously instantiated object will be the ‘parent’ of the newly instantiated user interface object in application hierarchy 104.

7. All attributes of the newly instantiated user interface object are initialized with the initial attribute values received in the “ST_CreateVisualobject” protocol message.

### EXAMPLE 2

Modifying Attribute Values via the ‘Instant Attribute’ Mechanism

The attribute values of existing objects may be modified. In an embodiment, the background color of an existing button object, B, could be set with the following C++ function call:

B.SetBackgroundColor(COLOR_BLUE);

In another preferred embodiment, the following C++ statement would achieve the same effect:

B.BackgroundColor=COLOR_BLUE;

In this embodiment basic C++ operators (i.e. “operator=”) are overloaded so that application developers may express attribute value changes as simple assignment statements.

In both of the aforementioned embodiments the application program treats the attribute change command as a protocol event, triggering an identical series of operations:

1. The old attribute value is compared with the new attribute value. If these values are identical, then no further processing occurs.

2. When the new value differs from the old value then the attribute value is set the new value, and a “ST_ChangeAttributeValue” protocol messages is encoded to include the identity of the object whose attribute value is modified, the identity of the attribute, which was modified, and the new modified value of the attribute.

3. The application program transmits this “ST_ChangeAttributeValue” protocol message to the universal client program.

4. The universal client program receives the “ST_ChangeAttributeValue” protocol message, decodes the information therein, and triggers an “CR_ChangeAttributeValue” protocol event.

5. The universal object logic in the universal client program handles this “CR_ChangeAttributeValue” protocol event and modifies the value of the specified attribute in the specified object to be the specified new value.

The term ‘Instant Attribute’ is sometimes used to denote the effect described above in actions 1 through 5. In the present invention, all classes of objects are imbued with sufficient logical expertise such that when attributes are programmatically modified, the task of communicating these changes from the application program to the universal client program is performed ‘instantly’, without any further effort on the part of the application developer. In this way, the application hierarchies in both the application program and the universal client program are kept logically synchronized, and developers of application programs using instances of the objects of the present invention are unburdened from the task of explicitly synchronizing the state of objects in the universal client program with the state of objects in the application program.

### EXAMPLE 3

Handling a Click Event

Certain events occurring within the universal client program may require that notification of those events be communicated to the application program. A ‘click’ is typically one such event; it is handled as follows:

1. Local input 132 is registered by local input handler 140 and identified as a click event.

2. Local input handler 140 examines the object hierarchy and determines which user interface object is the target of the click.

3. An ‘LocalClick’ protocol event is triggered for the user interface object 110 which is determined to be the target of the click.

4. The ‘LocalClick’ protocol event is handled by the universal object logic of the universal client program. The universal object logic is immediately responsible for producing appropriate visual feedback effects, as universally defined for the type of object that is the target of the click event.

5. Universal object logic then encodes a “CT_Click” protocol message to include the (X,Y) coordinate value of the location of the click, and the identity of object, which is the target of the click.

6. This “CT_Click” protocol message is then transmitted to the application program running on the server system.

7. The application program receives the “CT_Click” protocol message, decodes the information therein, and triggers a “SR_Click” protocol event in the application program.

8. Universal object logic in the application program handles the “SR_Click” protocol event and performs any operations required to logically synchronize the state of the application hierarchy 183 containing the node 7 which received the “CT_Click” protocol message with the application hierarchy 108 in the universal client program that transmitted the “CT_Click” protocol message.

9. Universal object logic then triggers a programmatic “OnClick” event for the interface object identified in the “CT_Click” message. This programmatic “OnClick” event is the means by which appropriate programmatic application logic is activated in the application program in response to a click event initiated on the client system.

Application Program Termination

Normal termination of the application program can happen for two reasons: (a) the programmatic application logic 114 concludes with a “Shutdown” operation, (b) there is an unexpected connection failure with the network connection to socket 70 of node 7. In either case similar action happen as follows:

1. The receive thread listening for input on socket 70 of node 7 is terminated by well-known methods.

2. An “OnShutdown” event is generated in the application program so that appropriate programmatic application logic can be executed.

3. All instantiated objects are destroyed.

4. The application executive 150 is terminated.

Administration of Server Program via Administration Application Object

Optionally, administration application object 590 makes a request using OS services to some application object 108 which comes in through event handler in main loop. The application responds in kind.

GPS-related embodiment

The GPS-related embodiment relates to a system that provides real-time bi-directional communication of data between a client system (e.g., a portable electronic device) in communication with a GPS, and a non-local server system, via the Internet.

FIG. 9G is a block diagram of apparatus 9G00, related to managing global positioning system (GPS) information, according to an embodiment of the invention.

Apparatus 9G00 comprises a client system 10 as in client 10 in FIG. 2, a server system 16 as in server 16 in FIG. 2, a plurality of global positioning system (GPS) satellites 971 in electromagnetic communication with the client system, and an Internet 970 or other such computer network. Client system 10 and server system 16 are in electronic communication with each other via Internet 970.

GPS satellites 971 are part of the existing, or future, satellite network placed into service for the purpose of facilitating calculation, with useful accuracy, of the location of a receiving device such as 10 in either two-dimensional or three-dimensional space with respect to some specified reference point. With reference to FIG. 9G, GPS satellite system 971 transmits data and highly accurate timing information via radio waves 972 on a continuing basis and according to well-known GPS standards and techniques.

FIG. 9H is a block diagram of apparatus 9H00 related to managing GPS information, according to an embodiment of the invention.

With reference to FIG. 9H, client system 10 optionally comprises a personal digital assistant (PDA) or a portable computing device, such as a Palm® Pilot®, an operating system 974, such as Palm-OS® or Microsoft CE, a GPS receiver device 973, and a universal client program. Running under operating system 974 is a universal client program to facilitate the operation of a plurality application programs running respectively on a plurality of server systems. In one embodiment, operating system 974 passes, by well-known methods, the output of the GPS device 973 to the universal client program 36 which then passes this GPS information to one or more of the server-side application programs for which it is facilitating control. In another embodiment, operating system 974 passes, by well-known methods, the output of the GPS device 973 to a GPS data conversion program 975 and then passes by the well-know method the output of 975 processed GPS data to the universal client program 36 which then passes this GPS information to one or more of the server-side application programs for which it is facilitating control. Universal client program 36 operates the functions of user interface 85, such as the display screen, data entry, and input “clicks” 85, via the operating system 974. Universal client program 36 also converts inputs from user interface 85 into protocol messages for transmission. This process is referred to herein as “protocol message encoding.”

Operating system 974 is further connected to a wireless TCP-IP or other network interface 970 that provides for bi-directional transmission of packetized data between the client system 10 and a server system 16 via the Internet or other digital network according to the standards and specifications of that network.

Server system 16 comprises a network interface, and a server computer, and an operating system 976, such as an Intel®-based microcomputer running Microsoft® Windows NT®. Operating system 976 has the ability to run and manage a plurality of general programs. Operating system 976 further manages communications with Internet 970, by sending and receiving packetized data via a network interface. Operating system 976 has the further ability to pass data between or among the network 970 and one or more executing general programs running on server computer 16.

Herein the term “application program” refers to a specialized software application which uses “SkyFire protocol messaging”. A “general” program refers to any software program, including “application programs”.

Server computer 16 further comprises a plurality of application programs 189. An application program 189 communicates with operating system 976 and also implements the “SkyFire protocol messaging”, enabling communication with universal client program 36 running on client system 10. Application program 189 also performs a variety of programmed functions related to the functionality desired for the user; the term “programmatic application logic” refers to this variety.

Further included in server system 16 (or electronically connected thereto) is one or more software databases, as indicated by databases 977 and 978, each containing data sets useful to an end-user who has access to server system 16. Databases 977 and 978 include information pertaining to the geographic location derived from GPS data. A database lookup can be performed, based on the GPS data communicated from the client system 10 via the Internet 970 or other network. This database access can be programmed using standard database software, such as Structured Query Language (SQL). An example of information stored in databases 977 and 978 is information about retail stores near the client's location, or information relating to a landmark in the vicinity of the client.

Protocol Messages

FIG. 9I is a diagram of a protocol message data structure for use in creating a visual object, according to an embodiment of the invention.

A CreateVisualobject protocol message includes 1 byte 980 indicating that it is a protocol message data structure for use in creating a visual object, such as “ST_CreateVisualobject.” The CreateVisualobject protocol message also includes 2 bytes 981 indicating the handle of object's parent, 2 bytes 983 indicating the type of the object, such as “Button,” 6 bytes 983 indicating the compressed attributes: X coordinate, Y coordinate, width, height. The CreateVisualobject protocol message further includes 1 byte 984 indicating the compressed attributes foreground color and/or the background color, 1 byte 985 indicating compressed attributes, such as visible and/or enabled, and 1 byte 986 indicating where applicable, the compressed attributes relating to the text style, such as underlined, italics, bold, size, font. The CreateVisualobject protocol message also optionally includes additional bytes (not shown) to indicate object-specific attributes.

In one embodiment of a CreateVisualobject protocol message, the complete memory representation of the object is sent in compressed form with a CreateVisualobject protocol message.

FIG. 9J is a diagram of a protocol message data structure for use in changing an attribute of a visual object, according to an embodiment of the invention.

A ChangeAttribute protocol message includes 1 byte 987 indicating that it is a protocol message data structure for use in changing an attribute of a visual object, such as “ST_ChangeAttribute.” The ChangeAttribute protocol message also includes 1 byte 988 indicating an attribute type, such as “AttributeType” and 2 bytes 989 indicating the handle of the object associated with the attribute to change. The ChangeAttribute protocol message also includes additional bytes (not shown) to indicate a new value.

In another embodiment of the ChangeAttribute protocol message, the complete memory representation of the object is sent with any change in which all attributes are updated simultaneously.

FIG. 9K is a diagram of a protocol message data structure for use in destroying a visual object, according to an embodiment of the invention.

A DestroyVisualobject protocol message includes 1 byte 990 indicating that it is a protocol message data structure for use in destroying a visual object, such as “ST_DestroyVisualobject.” The DestroyVisualobject protocol message also includes 2 bytes 991 indicating the handle of the object to destroy.

GPS-related Protocol Messages

Protocol Message CT_GPSUpdate

Protocol message CT GPSUpdate is transmitted from the universal client program to the application program. The message contains latitude/longitude/elevation (LLE) data, time-stamp data.

Optionally, protocol message CT_GPSUpdate contains protocol specific information relating to the user-input event the update is associated with. In one embodiment, the user input is the most recent user input event previous communicated. In another embodiment, the user input is the next user input event to be communicated. In yet another embodiment, the user input refers to a serialized event.

In still another embodiment, every user input event communicated to from the universal client program to an application program could have a unique (typically ascending) serial number. Every user input event is given a unique identification which places it in ordered serial relation to preceding and subsequent user input events, and by which the universal client program informs the server-side program (either the ‘server program’ or an ‘application program’) of this unique identity, by encoding it as part the protocol message used to communicate knowledge of the event itself.

In still yet another embodiment, a GPSupdate protocol message comprises error reporting information, such as when GPS reception fails on the client.

Protocol Message ST_GPSAvailableQuery

The protocol message ST_GPSAvailableQuery is a message sent by an application program to the universal client program to determine if the client system is capable of sending GPS information.

Protocol Message CT_GPSAvailableResponse

The protocol message CT_GPSAvailableResponse is a message sent by the universal client program in response to a ST_GPSAvailableQuery which encodes the specific GPS capabilities of the client system.

Protocol Message ST_GPSConfigure

The protocol message ST_GPSConfigure is a message sent by an application program to a universal client program which encodes the configuration specifying the manner in which the universal client will transmit CT_GPSUpdate messages. This configuration includes the format of the GPS/LLE data (such as absolute/relative), the user input events for which GPS updates will be sent with, activation/deactivation of GPS updates, the frequency that periodic GPS updates will be sent, and other GPS sub-system configuration parameters such as are well-known and generally practiced.

Conclusion to Apparatus Description

The components of the apparatus can be embodied as computer hardware circuitry or as a computer-readable program, or a combination of both. In another embodiment, the apparatus is implemented in an application service provider (ASP) system.

More specifically, in the computer-readable program embodiment, the programs can be structured in an object-orientation using an object-oriented language such as C++, Visual Basic, Smalltalk or Java, and the programs can be structured in a procedural-orientation using a procedural language such as COBOL or C. The software components communicate in any of a number of means that are well-known to those skilled in the art, such as application program interfaces (API) or interprocess communication techniques such as remote procedure call (RPC), common object request broker architecture (CORBA), Component Object Model (COM), Distributed Component Object Model (DCOM), Distributed System Object Model (DSOM) and Remote Method Invocation (RMI). The components execute on as few as one computer as in computer 110 in FIG. 1, or on at least as many computers as there are components.

### Methods of an Embodiment of the Invention

In the previous section, a system level overview of the operation of an embodiment of the invention was described. In this section, the particular methods performed by the server and the clients of such an embodiment are described by reference to a series of flowcharts. Describing the methods by reference to a flowchart enables one skilled in the art to develop such programs, firmware, or hardware, including such instructions to carry out the methods on suitable computerized clients (the processor of the clients executing the instructions from computer-readable media). Similarly, the methods performed by the server computer programs, firmware, or hardware are also composed of computer-executable instructions. Methods 1000-2900 are performed by a client program executing on, or performed by firmware or hardware that is a part of, a computer, such as computer 110 in FIG. 1.

Client Methods

FIG. 10 is a flowchart of a client method 1000 performed according to an embodiment of the invention.

Method 1000 includes launching a universal client 1010. Subsequently, method 1000 includes managing link requests 1020. Thereafter, method 1000 includes operating an application program via a universal client 1030.

FIG. 11 is a flowchart of a client method 1100 of one embodiment of the action of launching a universal client 1010 in FIG. 1000, performed according to an embodiment of the invention.

Method 1100 includes performing startup logic 1110, as in startup logic 126. Subsequently, method 1100 includes instantiating a root object 1120. In one embodiment the root object is instantiated by the startup logic 126. Thereafter, method 1100 includes instantiating a local link request application object 1130. In one embodiment the local link request application object 116 is instantiated by the startup logic 126. Thereafter, method 1100 includes creating a hierarchical relationship between the root object and a local link request application object 1140. In one embodiment the hierarchical relationship is created by the startup logic 126. Subsequently, method 1100 includes passing control to the local link request application object 1150. In one embodiment, passing control to the local link request application object enables acceptance of user input.

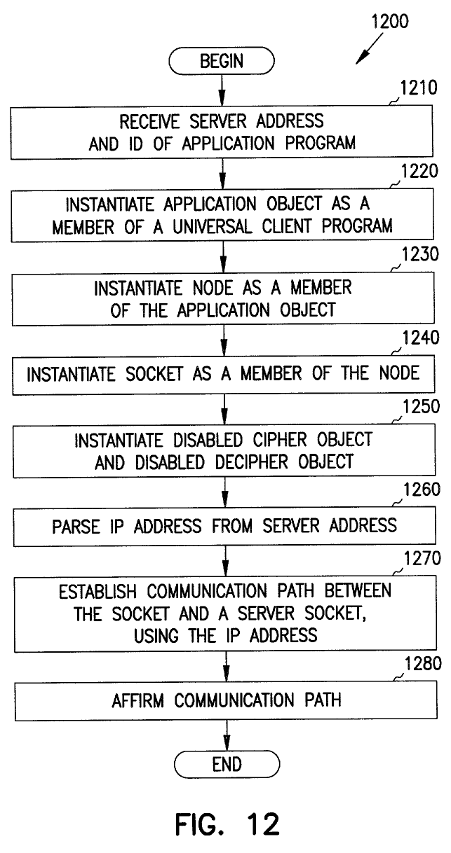

FIG. 12 is a flowchart of a method 1200 of one embodiment of the action of managing link requests 1020 in FIG. 1000, performed by a client according to an embodiment of the invention.

Method 1200 includes receiving a server address and an identification of an application program 1210. Thereafter, method 1200 includes instantiating an application object as a member of a universal client program 1220. In one embodiment, the application object is instantiated by the local link request application. Thereafter, method 1200 includes instantiating a node as a member of the application object 1230. Thereafter, method 1200 includes instantiating a socket as a member of the node 1240. Method 1200 also includes instantiating a disabled cipher object and a disabled decipher object 1250. In one embodiment the cipher object and the decipher object are instantiated as a member of the node. Thereafter, the IP address of the server is parsed from the server address 1260. A communication path, such as a TCP/IP or UDP/IP connection, is established between the client socket and a server socket using the IP address 1270, enabling the client to monitor incoming connection requests. Thereafter, the establishment of the communication path is affirmed 1280.

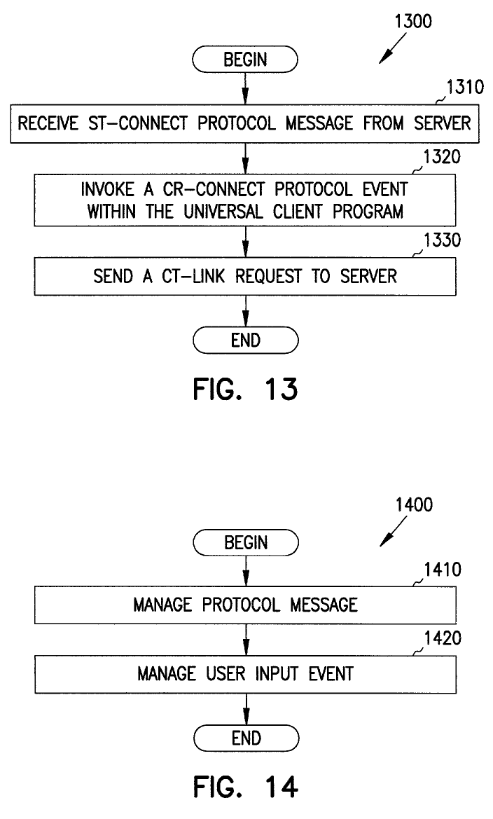

FIG. 13 is a flowchart of a method 1300 performed in conjunction with method 1200 by a universal client program according to an embodiment of the invention.

Method 1300 includes receiving a connect message from the server 1310. Thereafter, method 1300 includes invoking a connect protocol event within the universal client program 1320. Subsequently, method 1300 includes sending a link request protocol message to the server 1330.

FIG. 14 is a flowchart of a method 1400 of one embodiment of the action of operating an application program via the universal client 1030, performed by a client according to an embodiment of the invention.

Method 1400 includes managing a protocol message 1410. Thereafter, method 1400 includes managing a user input event 1420. 1420 is executed after an event has been accepted. In one embodiment, method 1400 is executed multiple times.

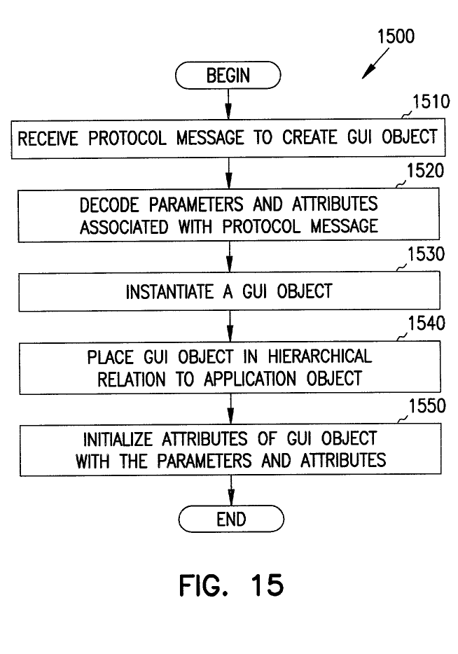

FIG. 15 is a flowchart of a method 1500 of one embodiment of the action of managing a protocol message 1410 in FIG. 14, performed by a client according to an embodiment of the invention.

Method 1500 includes receiving a message to create the GUI object 1510. In one embodiment the message is a message instructing, commanding, or requesting an action of creating visual object protocol. Thereafter, method 1500 includes decoding parameters and attributes associated with the message 1520. Subsequently, a GUI object is instantiated within the hierarchical relationship associated with the application object 1530. Thereafter, the graphical user interface object is placed in a hierarchical relationship to the application object 1540. Subsequently, method 1500 includes initializing the attributes of the GUI object with the parameters and attributes 1550.

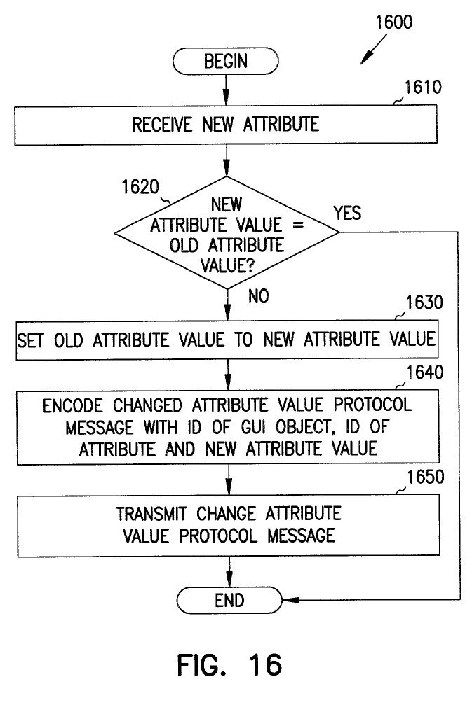

FIG. 16 is a flowchart of a method 1600, performed by a application program on a server in response to a receipt of a protocol message, according to an embodiment of the invention.

Method 1600 includes receiving programmatically a new attribute value 1610. Thereafter, the new attribute value is compared to an old attribute value 1620. If the comparison indicates equality, then the method 1600 terminates. Otherwise, if the comparison indicates inequality, the method continues by setting the attribute value to the new attribute value 1630. Thereafter, method 1600 includes encoding a change attribute value protocol message with the identification of the GUI object, the identification of the attribute and the new attribute value 1640. Subsequently, the protocol message is transmitted to a client 1650.

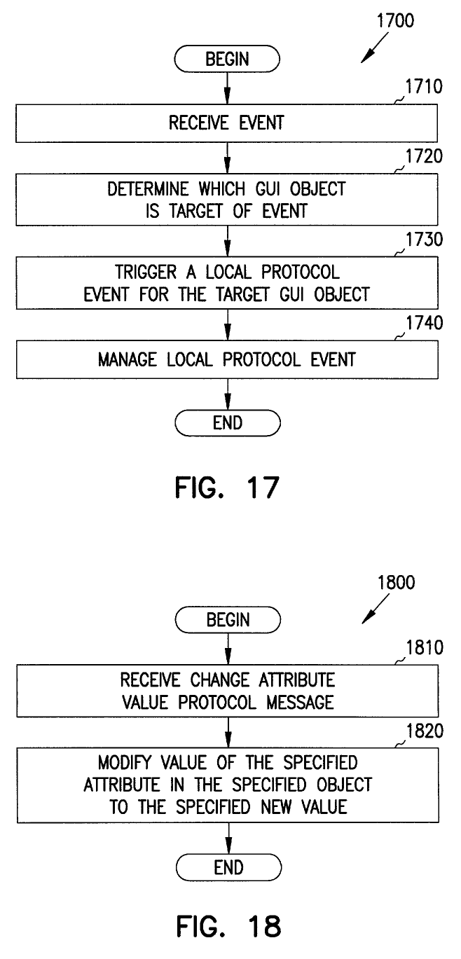

FIG. 17 is a flowchart of a method 1700 of one embodiment of the action of managing a user input event 1420 in FIG. 14, performed according to an embodiment of the invention.

Method 1700 includes receiving an event 1710. In one embodiment a local input handler 140 registers the event. Thereafter, method 1700 includes determining which GUI object is the target of the event 1720. Subsequently, method 1700 includes triggering a local protocol event for the target GUI object 1730. Thereafter, the universal client program 1740 manages the local protocol event.

FIG. 18 is a flowchart of a method 1800 of managing a protocol message 1410 in FIG. 14, performed by a universal client program in response to receiving a change attributes value protocol message, according to an embodiment of the invention.

Method 1800 includes receiving the change attribute value protocol message 1810. Thereafter, method 1800 includes modifying the value of the specified attribute in the specified object to the specified new value 1820. In one embodiment action 1820 is performed by the universal object logic in the universal client program.

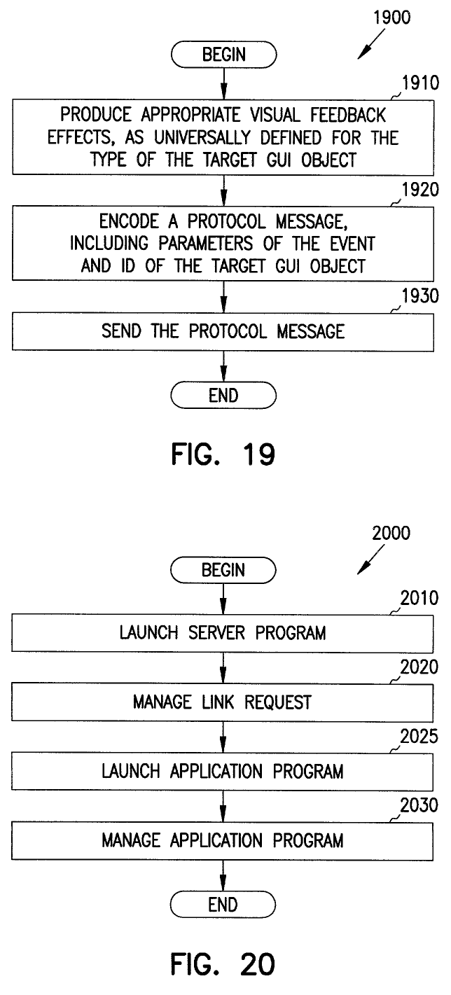

FIG. 19 is a flowchart of a method 1900 of one embodiment of the action of managing a local protocol event 1740 in FIG. 17, performed by the universal object logic of the universal client program according to an embodiment of the invention.

Method 1900 includes producing appropriate visual feedback effects, as universally defined for the type of the target GUI object 1910. Method 1900 also includes encoding a protocol message, including coordinates of the event and the ID of the target GUI object 1920. Subsequently, method 1900 includes sending the message 1930.

Server Methods

FIG. 20 is a flowchart of a method 2000 performed by a server according to an embodiment of the invention in conjunction with client methods 1000-1900.

Method 2000 includes launching a server program 2010. Thereafter, the method includes managing link requests 2020. Method 2000 also includes launching an application program 2025. Subsequently, method 2000 includes managing the application program 2030.

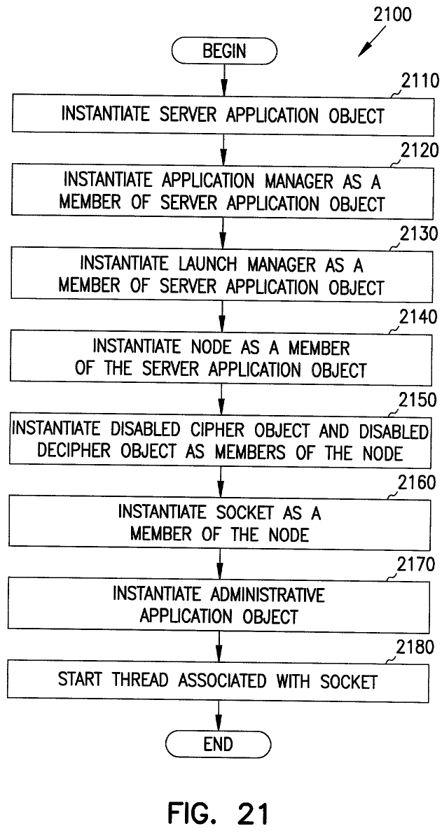

FIG. 21 is a flowchart of a method 2100 of one embodiment of the action of launching the server program 2010 in FIG. 20, performed by an operating system of a server according to an embodiment of the invention.

Method 2100 includes instantiating a server application object 2110. Thereafter, the method includes instantiating a server manager as a member of the server application object 2120. Also, method 2100 includes instantiating a launch manager as a member of the server application object 2130, and instantiating a node as a member of the server application object 2140. Thereafter, a disabled cipher object and a disabled decipher object are instantiated as members of the node 2150. Method 2100 also includes instantiating a socket as a member of the node 2160. Subsequently, an administrative server object is instantiated 2170. Thereafter, a thread associated with the socket is started 2180.

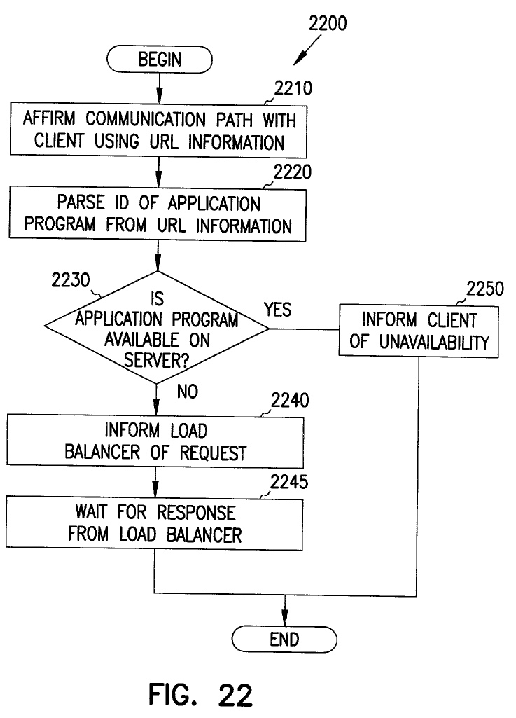

FIG. 22 is a flowchart of a method 2200 of one embodiment of the action of managing link requests 2020 in FIG. 20, performed by a server according to an embodiment of the invention.

Method 2200 includes affirming the communication path with the client, using URL information 2210. Thereafter the ID of the application program is parsed from the URL information 2220. Subsequently, a determination as to whether or not the application program is available on the server 2230. Where the application program is not available on the server, the method continues with informing the client of the server unavailability 2250, thereafter which the method ends. Otherwise, where the application program is available on the server, the method continues with informing a load balancer of the request 2240. Thereafter, the method waits for a response from the load balancer 2250.

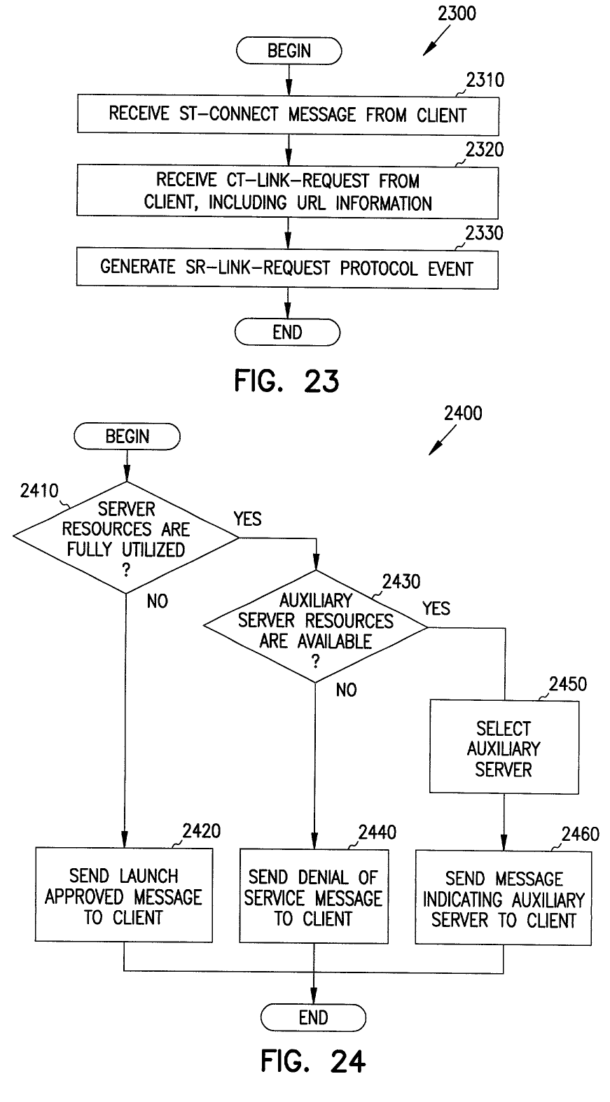

FIG. 23 is a flowchart of a method 2300 of one embodiment of the action of affirming the communication path 2210 in FIG. 22, performed according to an embodiment of the invention.

Method 2300 includes sending an ST connect message to the client 2310. Thereafter, the method includes receiving a link request from the client 2230. In one embodiment the link request includes URL information. Subsequently, method 2300 includes generating a link request protocol event 2330.

FIG. 24 is a flowchart of a method 2400 of one embodiment of the action of determining the availability of the application program on the server 2230 in FIG. 22, performed by the load balancer 550 according to an embodiment of the invention.

In one embodiment, method 2400 includes determining whether or not server resources are fully utilized 2410. Where the determination resolves an indication of less than fully utilized server resources, the load balancer sends a launch-approved message to the client 2420. Where the server resources are fully utilized, the method continues by determining whether or not auxiliary server resources are available 2430. Where auxiliary server resources are not available, the method continues by sending a denial of service message to the client 2440. Where auxiliary server resources are available, the method continues by selecting an auxiliary server 2450 and sending a message indicating the selected auxiliary server to the client 2460.

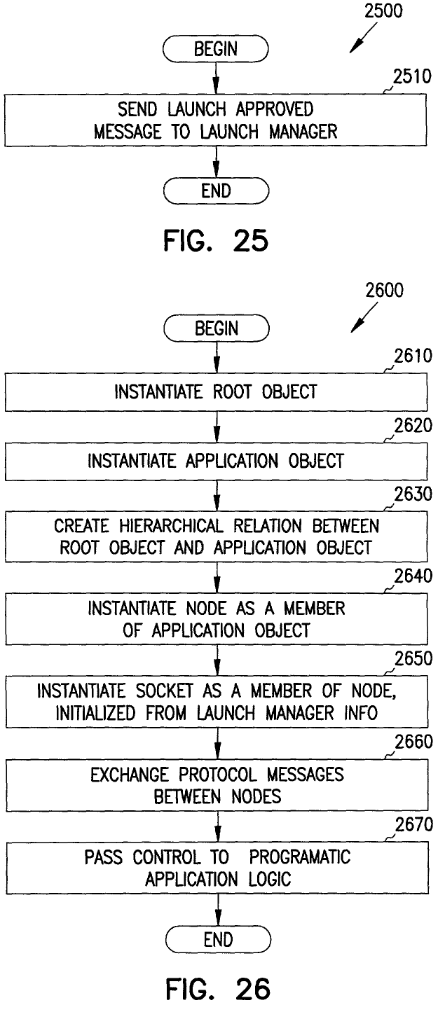

FIG. 25 is a flowchart of a method 2500 of one embodiment of the action of informing the load balancer of the request 2240 in FIG. 2200, performed according to an embodiment of the invention.

Method 2500 includes sending a launch-approved message to the launch manager 2510.

FIG. 26 is a flowchart of a method 2600 of one embodiment of a method performed in response to sending a launch-approved message to the client 2420 in FIG. 24, performed by a server according to an embodiment of the invention.

Method 2600 includes instantiating a root object 2610. Method 2600 includes instantiating an application object 2620. In varying embodiments, action 2610 is performed before, during, and/or after action 2620. Thereafter, a hierarchical relation is created between the root object and the application object 2630. After action 2620, a node is instantiated 2640 as a member of the application object. Thereafter, the method includes instantiating a socket as a member of member of the node 2650. The socket is instantiated from information derived from a launch manager. Subsequently, method 2600 includes exchanging streaming data between the node and a client node 2660. Thereafter, control is passed programmatic application logic 2670.

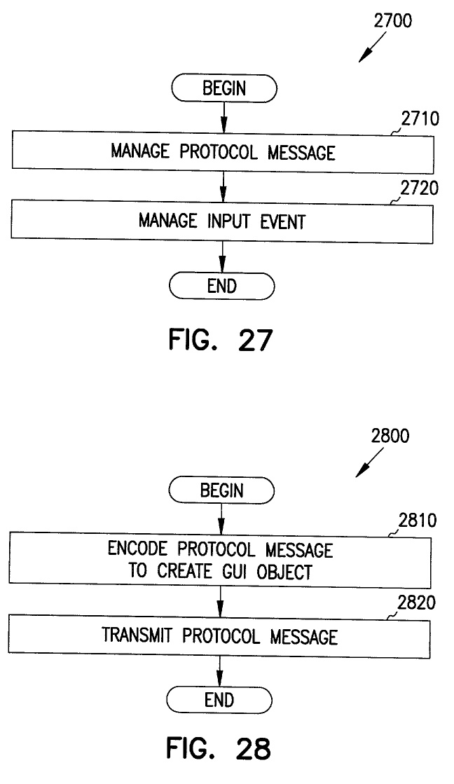

FIG. 27 is a flowchart of a method 2700 of one embodiment of managing the application program 2030 in FIG. 2000, performed by a server according to an embodiment of the invention.

Method 2700 includes managing a protocol message 2710. Thereafter, method 2700 includes managing internal events 2720. 2720 is executed after an event has been accepted. In one embodiment, method 2700 is executed multiple times.

FIG. 28 is a flowchart of a method 2800 of one embodiment of the action of creating GUI objects 2710 in FIG. 27, performed according to an embodiment of the invention.

Method 2800 includes encoding a protocol message indicating creation of GUI objects 2810. Method 2800 thereafter includes transmitting the protocol message 2820.

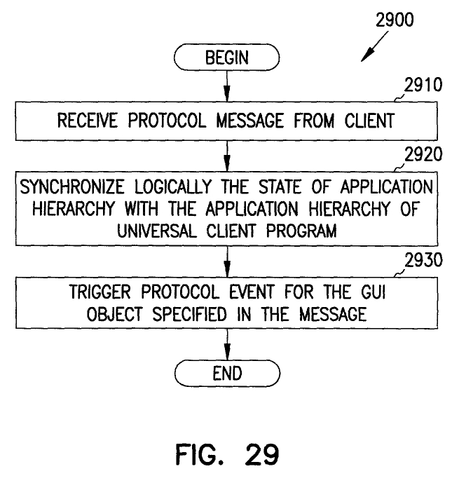

FIG. 29 is a flowchart of a method 2900 of one embodiment of the action of managing protocol messages 2730 in FIG. 27, performed by a server according to an embodiment of the invention.

Method 2900 includes receiving a protocol message from the client 2910. Thereafter, method 2900 includes logically synchronizing the state of the application hierarchy to the application hierarchy of the universal client program of the client 2920. Subsequently, a protocol event for the GUI object specified in the message is triggered 2930.

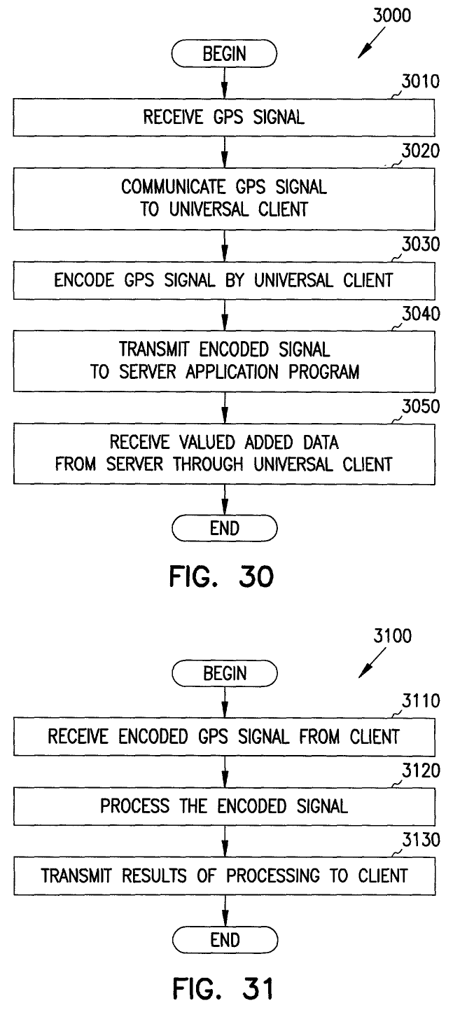

FIG. 30 is a flowchart of a method 3000 of one embodiment of the action of managing GPS information, performed by a client according to an embodiment of the invention.

Method 3000 includes receiving 3010 GPS signals. In one embodiment, client system 10 receives radio-frequency signals 125 from a number of GPS satellites 120. The GPS sub-system of client system 10 collects, analyzes, and interprets GPS data to yield accurate location information.

Method 3000 also includes communicating GPS signals to a universal client program 3020. In one embodiment of action 3020, the GPS sub-system that is integrated into client system 10 communicates GPS signals to the universal client program running by well-known methods according to the operating system of client system 10.

Method 3000 thereafter includes encoding GPS and other information 3030. The universal client system encodes, into protocol message form, certain information including the GPS location information, data corresponding to user input events, such as user interface button clicks, and time-stamp information corresponding to the time that GPS location information and user input events happened.

Subsequently, method 3000 includes transmitting GPS and other information 3040. Universal client program transmits the encoded protocol message(s) containing GPS information and other information, as encoded, to the appropriate application program running on server computer 16 via Internet 970.

Method 3000 also includes receiving 3050 added value data from server computer 16 through Internet 970 by the universal client program running on client system 10. Added value data comprises a vast range of possible information including any user interface alteration supported by the universal client program, one-time data updates, periodic/dynamic data updates, continuous real-time data updates, notification of server-side configuration changes, and other information of commercial value.

Subsequently, method 3000 includes enabling 3060 viewing and/or listening to the value added data. In one embodiment, the universal client program presents the transmitted results to the user, optionally by updating the user interface on the client system 10.

FIG. 31 is a flowchart of a method 3100 of one embodiment of the action of managing GPS information, performed by a server according to an embodiment of the invention.

Method 3100 includes receiving 3110 an encoded GPS signal data from client system 3110. In one example, an application program running on server system 16 receives protocol message(s) containing GPS location and other data from terminal device 10 via Internet 970.

Method 3100 also includes processing 3120 GPS data and other data. In one embodiment, the application program running on server system 16 utilizes the GPS location data in conjunction with other information sources available to the server and/or provided by the client terminal, to access added value information determined to be useful to the user of client terminal 10.

Thereafter, method 3000 includes transmitting 3130 the results of the processing action 3130. In one example, the added value data is transmitted from server computer 16 through Internet 970 to the universal client program running on client system 10. Added value data comprises a vast range of possible information including any user interface alteration supported by the universal client program, one-time data updates, periodic/dynamic data updates, continuous real-time data updates, notification of server-side configuration changes, and other information of commercial value.

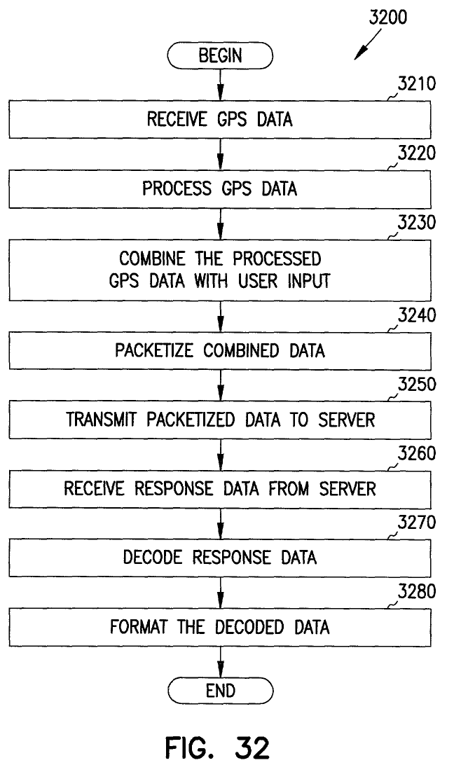

FIG. 32 is a flowchart of a method 3200 of one embodiment of the action of managing GPS information, performed by a client according to an embodiment of the invention.

Method 3200 includes receiving GPS data 3210. In one embodiment of action 3210 a GPS receiver 973, operating according to well-known standards for the GPS system, receives timing signals 125 in the form of ASCII codes transmitted by radio waves from array of earth-orbiting satellites 971. The GPS data are passed from GPS receiver 973 operating system 974.

Subsequently, the method 3200 includes processing the GPS data 3220. In one example of processing the GPS data, an operating system 974 passes the GPS data to software program 975 which implements well-known GPS algorithms to convert the raw GPS data into digital representations of the latitude, longitude, and elevation (LLE) of client terminal 10. The LLE data is then returned to operating system 974.

Thereafter, the processed GPS Data is combined 3230 with user input: For example, an operating system 974 combines the GPS/LLE data with protocol messages from universal client program 36 containing encoded representation of user actions involving the user interface elements provided and managed by the universal client program.

Subsequently, method 3200 includes packetizing the mobile terminal server (MTS) data and the GPS data 3240. In one embodiment of action 3240, the MTS and GPS data are packetized according to TCP-IP specifications and transmitted through Internet 970. The TCP-IP protocol ensures that data packets intended for the universal client program 36 and application program 240 are properly transmitted, received, decoded and passed to the correct software program.

Thereafter, the packetized data is transmitted to a server 3250.

Subsequently, method 3200 includes receiving response data from the server 3260. In one example, the client system 10 hardware receives TCP-IP data packets through its connection to Internet 970.

In action 3270 of method 3200, the received data is decoded. In one embodiment, operating system 974 in client terminal 10 decodes the TCP-IP data packets and directs encoded protocol message to the universal client program 36.

Subsequently, method 3200 includes formatting 3380 the decoded data. In one example of action 3380, the Universal client program 200 decodes the protocol message and optionally presents the value-added information by altering aspect of the user interface.

Furthermore, a human user 979 of the client acts on the formatted information. A user 979 perceives value-added information on which to further act, based on geographic location, previous user actions, and the times at which these previous user actions were performed.

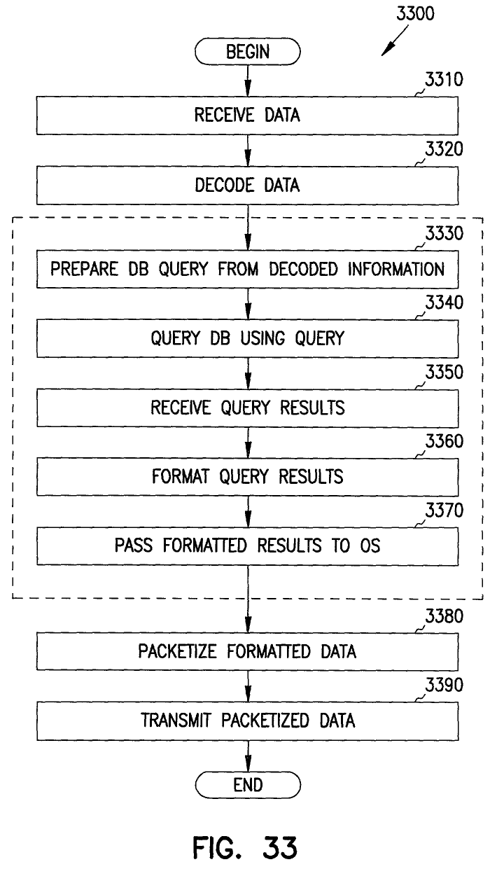

FIG. 33 is a flowchart of a method 3300 of one embodiment of managing GPS information, performed by a server according to an embodiment of the invention.

Method 3300 includes receiving GPS-related data 3310. In one embodiment, action 3300 is performed in conjunction with action 3250 in FIG. 3200, in which the packetized data that is transmitted in action 3250 is received by a server. Server system 16 receives TCP-IP traffic through a connection with Internet 970.

Thereafter, method 3300 includes decoding and passing the data 3320. Operating system 976 in server system 16 decodes the TCP-IP packets and directs the LLE and MTS data to application program 189.

Subsequently, the method includes an Application program 189 preparing 3330 a database query using the LLE and MTS data. The Application program queries 3340 a database using the query. In one embodiment, the database query is sent to database 977 by operating system 976.

Thereafter, method 3300 includes receiving query results 3350. In one embodiment, the database 977 returns the desired information to operating system 976. Further to that embodiment, the method includes passing data to an application program, wherein the operating system 976 passes the desired data to application program 189.

Subsequently, the method 3300 includes formatting 3360 the received query data 3360. In one embodiment, the Application program 189 formats the data for delivery to universal client program 36, by encoding this data into protocol messages.

Thereafter, the formatted data is passed to the operating system 976. In one embodiment of action 3370, the protocol messages are passed to operating system 976.

Subsequently, method 3300 includes packetizing 3380 the formatted data. In one embodiment, operating system 976 packages the protocol messages within TCP-IP packets destined for client system 10.

Furthermore, method 3300 includes transmitting 3390 the packetized data. In one example of transmitting 3390, the TCP-IP packets are transmitted over Internet 970.

An example of an application of methods 3000-3300 involves a tourist end-user 979 traveling to visit a National Park. End-user 979 carries a handheld client computer 10, which includes a GPS receiver. Universal client program 36 running on handheld client computer 10 permits user 979 to inquire about camping sites within 10 miles of the user's location via user-interface 85. This may involve, for example, clicking a series of button objects in a window object presented on the client computer's touch-sensitive display. Next, the user's request is received by the universal client program 36. Next, along with GPS/LLE data from a GPS sub-system 975 on the client system, the user's request is transmitted wirelessly to Internet 130 and to an application program 189 running on server system 110, which correlates location information against a dynamic geographic database 977 of campgrounds. Database 977 also contains other information including campsite reservations, fees, and facilities.

Application program 189 formats a database query based on the information desired by user 979, and the location of the user. The query is submitted to database 977 residing on the server computer 110, or possibly on a remote database server in network connection with server computer 110. In response to the query, database 977 returns data, such as information about all camping grounds within a distance or travel time selected by end-user 979. Application program 189 then formats the response for presentation by the universal client program running on client computer 10. The campground data is encoded in protocol messages and sent through Internet 130 to client system 10, where it is received by universal client program 36, which then decodes and interprets this data as a list of campgrounds to be then displayed on the user interface 85. At this point, the process may iterate. The user might select a particular campground based on the currently presented information obtained from database 977. Optional subsequent transactions allow end-user 979 to query the availability of campsites at a given campground, and optionally reserve a campsite via other external services available to application program 189.

In an alternative embodiment, operating system 974 passes the GPS data to a software GPS data conversion program 975, which implements well-known GPS algorithms to convert raw GPS data into digital representations of LLE on user interface 85. Current LLE data is compared to previous LLE data stored by program 975, and an output is returned to the operating system that represents the magnitude of change in the geographic location of client system 10. For example, GPS position information might only be sent to application program 189 if the GPS device has moved a specified distance, such as 5 meters in any direction, as computed by GPS data conversion program 975. Further, the data sent may represent only the magnitude and direction of the change in geographic position, rather than the absolute position of client system 10. For example, the returned data may indicate “+7 meters, −15 degrees, +1 meter elevation,” with the direction based on compass settings. On a periodic basis, application program 189 can request or be provided with an absolute position bearing to correct cumulative errors obtaining from compounding inaccuracies in relative position bearings.

In another alternative embodiment, the GPS data is passed directly to application program 189 and analyzed on server system 110 to determine an accurate location of client system 10. In this case, the GPS data conversion program 975 simply passes the raw GPS data to operating system 974, which sends it through Internet 130 to server system 110.

In one embodiment, methods 1000-3200 are implemented as a computer data signal embodied in a carrier wave, that represents a sequence of instructions which, when executed by a processor, such as processor 164 in FIG. 1, cause the processor to perform the respective method.

### Conclusion

A client/server system for operating server-based application from a client has been described. Although specific embodiments have been illustrated and described herein, it will be appreciated by those of ordinary skill in the art that any arrangement, which is calculated to achieve the same purpose, may be substituted for the specific embodiments shown. This application is intended to cover any adaptations or variations of the present invention. For example, although described in object-oriented terms, one of ordinary skill in the art will appreciate that the invention can be implemented in a procedural design environment or any other design environment that provides the required relationships.

Systems and methods are provided through which an application is executed on a server, and operated from a client operably coupled to the server. State information of the application is maintained through parallel objects on both the client and the server, thereby minimizing the communications requirements between the client and the server in the operation of the application. More specifically, the communications requirements and updates of attributes of the application is minimized.

Systems and methods are provided which includes a client receiving a global positioning system (GPS) signal, communicating the GPS signal to a universal client program, encoding the GPS signal by the universal client program, transmitting the encoded data to a server, receiving value added data an application program that has a synchronized state with the universal client program from server computer, and enabling viewing of the value added data on the client.

In particular, one of skill in the art will readily appreciate that the names of the methods and apparatus are not intended to limit embodiments of the invention. Furthermore, additional methods and apparatus can be added to the components, functions can be rearranged among the components, and new components to correspond to future enhancements and physical devices used in embodiments of the invention can be introduced without departing from the scope of embodiments of the invention. One of skill in the art will readily recognize that embodiments of the invention are applicable to future communication devices, different file systems, and new data types.

The terminology used in this application with respect to is meant to include all object-oriented, database and communication environments and alternate technologies, which provide the same functionality as, described herein. Therefore, it is manifestly intended that this invention be limited only by the following claims and equivalents thereof.

We claim:

1. A client method for managing global-positioning-system information, comprising:
receiving a global-positioning-system signal;
communicating the global-positioning-system signal to a universal client program;
encoding the global-positioning-system signal by the universal client program;
transmitting the encoded data to a server;
receiving value added data from the server computer; and
enabling viewing of the value added data.

2. The method as recited in claim 1, wherein receiving a global-positioning-system signal further comprises:
receiving radio-frequency signals from a plurality of global-positioning-system satellites

3. The method as recited in claim 1, wherein encoding the global-positioning-system signal by the universal client program further comprises:
encoding into protocol message form, certain information including global-positioning-system location information derived from the global-positioning-system signal, data corresponding to user input events

4. The method as recited in claim 3, wherein data corresponding to user input events further comprises data selected from the group consisting of user interface button clicks, and time-stamp information corresponding to the time that global-positioning-system location information and user input events.

5. The method as recited in claim 1, wherein transmitting the encoded data to a server further comprises:
transmitting through the Internet an encoded and encrypted protocol message containing global-positioning-system information and other information, by the universal client program, to an application program executing on a server computer.

6. The method as recited in claim 1, wherein enabling viewing of the value added data further comprises:
presenting the transmitted value added data to the user by the universal client program.

7. The method as recited in claim 6, wherein presenting the transmitted value added data to the user by the universal client program further comprises:
updating the user interface of the client system.

8. A computer-readable medium having computer-executable instructions to cause a client computer to perform a method comprising:
receiving a global-positioning-system signal;
communicating the global-positioning-system signal to a universal client program;
encoding the global-positioning-system signal by the universal client program;
transmitting the encoded data to a server;
receiving value added data from server computer; and
enabling viewing of the value added data.

9. The computer-readable medium as recited in claim 8, wherein receiving a global-positioning-system signal further comprises:
receiving radio-frequency signals from a plurality of global-positioning-system satellites

10. The computer-readable medium as recited in claim 8, wherein encoding the global-positioning-system signal by the universal client program further comprises:
encoding into protocol message form, certain information including global-positioning-system location information derived from the global-positioning-system signal, data corresponding to user input events

11. The computer-readable medium as recited in claim 10, wherein data corresponding to user input events further comprises data selected from the group consisting of user interface button clicks, and time-stamp information corresponding to the time that global-positioning-system location information and user input events.

12. The computer-readable medium as recited in claim 8, wherein transmitting the encoded data to a server further comprises:
transmitting through the Internet an encoded and encrypted protocol message containing global-positioning-system information and other information, by the universal client program, to an application program executing on a server computer.

13. The computer-readable medium as recited in claim 8, wherein enabling viewing of the value added data further comprises:
presenting the transmitted value added data to the user by the universal client program.

14. The computer-readable medium as recited in claim 13, wherein presenting the transmitted value added data to the user by the universal client program further comprises:
updating the user interface of the client system.

15. A computer data signal embodied in a carrier wave and representing a sequence of instructions which, when executed by a processor, cause the processor to perform the method of:
receiving a global-positioning-system signal;
communicating the global-positioning-system signal to a universal client program;
encoding the global-positioning-system signal by the universal client program;
transmitting the encoded data to a server;
receiving value added data from server computer; and
enabling viewing of the value added data.

16. The computer data signal as recited in claim 15, wherein receiving a global-positioning-system signal further comprises:
receiving radio-frequency signals from a plurality of global-positioning-system satellites

17. The computer data signal as recited in claim 15, wherein encoding the global-positioning-system signal by the universal client program further comprises:
encoding into protocol message form, certain information including global-positioning-system location information derived from the global-positioning-system signal, data corresponding to user input events

18. The computer data signal as recited in claim 17, wherein data corresponding to user input events further comprises data selected from the group consisting of user interface button clicks, and time-stamp information corresponding to the time that global-positioning-system location information and user input events.

19. The computer data signal as recited in claim 15, wherein transmitting the encoded data to a server further comprises:
transmitting through the Internet an encoded and encrypted protocol message containing global-positioning-system information and other information, by the universal client program, to an application program executing on a server computer.

20. The computer data signal as recited in claim 15, wherein enabling viewing of the value added data further comprises:
presenting the transmitted value added data to the user by the universal client program.

21. The computer data signal as recited in claim 20, wherein presenting the transmitted value added data to the user by the universal client program further comprises:
updating the user interface of the client system.

22. A client method for managing global-positioning-system information, comprising:
receiving global-positioning-system data;
converting the global-positioning-system data into digital representations of the latitude, longitude, and elevation;
combining the digital representation with an encoded representation of user actions involving the user interface elements provided and managed by a universal client program;
packetizing mobile terminal server data and the combined data;
transmitting the packetized data to a server;
receiving response data from the server, including value-added information;
decoding the received data;
formatting the decoded data;
decoding the formatted data by the universal client program; and
presenting the decoded value-added information by altering an aspect of the user interface, by the universal client program.

23. A computer-readable medium having computer-executable instructions to cause a client computer to perform a method comprising:
receiving global-positioning-system data;
converting the global-positioning-system data into digital representations of the latitude, longitude, and elevation;
combining the digital representation with an encoded representation of user actions involving the user interface elements provided and managed by a universal client program;
packetizing mobile terminal server data and the combined data;
transmitting the packetized data to a server;
receiving response data from the server, including value-added information;
decoding the received data;
formatting the decoded data;
decoding the formatted data by the universal client program; and
presenting the decoded value-added information by altering an aspect of the user interface, by the universal client program.

24. A computer data signal embodied in a carrier wave and representing a sequence of instructions which, when executed by a processor, cause the processor to perform the method of:
receiving global-positioning-system data;
converting the global-positioning-system data into digital representations of the latitude, longitude, and elevation;
combining the digital representation with an encoded representation of user actions involving the user interface elements provided and managed by a universal client program;
packetizing mobile terminal server data and the combined data;
transmitting the packetized data to a server;
receiving response data from the server, including value-added information;
decoding the received data;
formatting the decoded data;
decoding the formatted data by the universal client program; and
presenting the decoded value-added information by altering an aspect of the user interface, by the universal client program.

25. A server method for managing global-positioning-system information, comprising:
receiving an encoded global-positioning-system signal data from a client system, by an application program;
processing the global-positioning-system data by the application program running on server system, in conjunction with another information source available to the server; and
transmitting the results of the processing to the client.

26. A computer-readable medium having computer-executable instructions to cause a server computer to perform a method comprising:
receiving an encoded global-positioning-system signal data from a client system, by an application program;
processing the global-positioning-system data by the application program running on server system, in conjunction with another information source available to the server; and
transmitting the results of the processing to the client.

27. A computer data signal embodied in a carrier wave and representing a sequence of instructions which, when executed by a processor, cause the processor to perform the method of:
receiving an encoded global-positioning-system signal data from a client system, by an application program;
processing the global-positioning-system data by the application program running on server system, in conjunction with another information source available to the server; and
transmitting the results of the processing to the client.

28. A server method for managing global-positioning-system information, comprising:
receiving global-positioning-system-related data;
decoding mobile terminal server and digital representations of the latitude, longitude, and elevation;
passing the mobile terminal server and the digital representations of the latitude, longitude, and elevation an application program;
preparing a database query from the mobile terminal server data and the digital representations of the latitude, longitude, and elevation;
performing the database query;
receiving query results by an application program;
formatting the received query results into protocol messages by the application program for delivery to a universal client program;
packetizing the formatted data; and
transmitting the packetized data to a client.

29. A computer-readable medium having computer-executable instructions to cause a server computer to perform a method comprising:
receiving global-positioning-system-related data;
decoding mobile terminal server and digital representations of the latitude, longitude, and elevation;
passing the mobile terminal server and the digital representations of the latitude, longitude, and elevation an application program;
preparing a database query from the mobile terminal server data and the digital representations of the latitude, longitude, and elevation;
performing the database query;
receiving query results by an application program;
formatting the received query results into protocol messages by the application program for delivery to a universal client program;
packetizing the formatted data; and
transmitting the packetized data to a client.

30. A computer data signal embodied in a carrier wave and representing a sequence of instructions which, when executed by a processor, cause the processor to perform the method of:
receiving global-positioning-system-related data;
decoding mobile terminal server and digital representations of the latitude, longitude, and elevation;
passing the mobile terminal server and the digital representations of the latitude, longitude, and elevation an application program;
preparing a database query from the mobile terminal server data and the digital representations of the latitude, longitude, and elevation;
performing the database query;
receiving query results by an application program;
formatting the received query results into protocol messages by the application program for delivery to a universal client program;
packetizing the formatted data; and
transmitting the packetized data to a client.

31. A computerized apparatus, comprising:
a processor;
a global-positioning-system receiver device, operably coupled to the processor;
an operating system executing on the processor and operably coupled to the receiver device that receives, that receives output of the global-positioning-system device; and
a universal client program that facilitates the operation of a plurality application programs running respectively on a plurality of operably coupled server systems, that receives the output of the global-positioning-system device from the operating system, and passes the output of the global-positioning-system device to the at least one of the application programs, operates the functions of user interface.

32. The computerized apparatus recited in claim 31, wherein the universal client program further converts inputs from the user interface into protocol messages for transmission to at least one of the application programs.

33. A computerized apparatus, comprising:
a processor;
an operating system executing on the processor and operably coupled to the receiver device that receives, that receives output data of a global-positioning-system device on a separate computerized apparatus; and
a plurality of application programs executing on the processor, operably coupled to the operating system, and enabled for communication with a universal client program on a separate computerized apparatus, that performs at least one programmed function related to the functionality associated with a user.

34. The computerized apparatus recited in claim 33, further comprising:
at least one database operably coupled to at least one of the application programs, the at least one database having data sets associated with a user who has access to server system, and the at least one database having information pertaining to the geographic location derived from the global-positioning-system data.
